(19) United States
(12) Patent Application Publication
(10) Pub. No.: US 2021/0165562 A1
(43) Pub. Date: Jun. 3, 2021

(54) DISPLAY CONTROL APPARATUS AND CONTROL METHOD THEREOF

(71) Applicant: CANON KABUSHIKI KAISHA, Tokyo (JP)

(72) Inventors: Shuichiro Matsushima, Tokyo (JP); Takuro Miyajima, Kanagawa (JP)

(21) Appl. No.: 17/103,795

(22) Filed: Nov. 24, 2020

(30) Foreign Application Priority Data
Nov. 29, 2019 (JP) 2019-217579

(51) Int. Cl. G06F 3/0484; G06F 3/0488; G06F 3/0482; H04N 5/232

(52) U.S. Cl. CPC G06F 3/04845; G06F 3/0488; H04N 5/232933; H04N 5/23229; G06F 3/0482

(57) ABSTRACT

A display control apparatus includes a touch detection unit configured to detect a touch operation on a surface of a display, a change unit configured to change a virtual position which is for performing predetermined image processing on an object, and a control unit configured to display a first item indicating a positional relationship of the virtual position to the object, in a case where a touch operation is performed, not to change the positional relationship indicated on the first item in response to a start position of the touch operation and to change the positional relationship in response to movement of a touch position from a positional relationship indicated on the first item at a start of the touch operation.

### BACKGROUND

### Field of the Disclosure

The present disclosure relates to a display control apparatus and a control method thereof, and more particularly to a technique in applying an effect to an image.

### Description of the Related Art

Image processing for applying an effect of illumination with light from a virtual light source to an object in a captured image, or virtual light source processing, has been known. Japanese Patent Application Laid-Open No. 2018-10496 discusses a technique in which an illumination direction of a virtual light source can be changed by a touch operation on a screen.

According to Japanese Patent Application Laid-Open No. 2018-10496, a virtual light source is provided at a position corresponding to a touched position. Therefore, in a case where a user wants to illuminate an object from near in front of the object, the user's finger performing a touch operation and the object overlap each other. This causes difficulty for the user to observe an effect of the virtual light source while performing the touch operation.

### SUMMARY

The present disclosure is directed to providing a display control apparatus that improves the user's operability in changing the degree of effect on an object by a touch operation.

According to an aspect of the present disclosure, a display control apparatus includes a touch detection unit configured to detect a touch operation on a surface of a display, a change unit configured to change a virtual position from which predetermined image processing is performed on an object displayed on the display, and a control unit configured to display a first item indicating a positional relationship of the virtual position to the object, the control unit being configured to control the change unit, in a case where the touch detection unit detects a touch operation on the surface of the display, to not change the positional relationship indicated on the first item in response to a start position of the touch operation and to change the positional relationship indicated on the first item in response to movement of a touch position of the touch operation from a positional relationship indicated on the first item at a start of the touch operation.

Further features of the present disclosure will become apparent from the following description of exemplary embodiments with reference to the attached drawings.

### BRIEF DESCRIPTION OF THE DRAWINGS

FIG. 1A is a block diagram of a digital camera that is an example of an apparatus to which an exemplary embodiment of the present disclosure can be applied. FIG. 1B is an external view of the digital camera that is an example of the apparatus to which the exemplary embodiment of the present disclosure can be applied.

FIG. 2 is a flowchart illustrating raw development editing processing according to one or more aspects of the present disclosure.

FIGS. 3A and 3B are flowcharts illustrating virtual light source editing processing according to one or more aspects of the present disclosure.

FIG. 4 is a flowchart illustrating face selection processing according to one or more aspects of the present disclosure.

FIG. 5 is a flowchart illustrating touch-move processing according to one or more aspects of the present disclosure.

FIGS. 6A to 6J are diagrams each illustrating an example of a display screen according to one or more aspects of the present disclosure.

FIG. 7 is a diagram for describing a direction of a virtual light source according to one or more aspects of the present disclosure.

FIGS. 8A to 8C are diagrams for describing a touch operation according to one or more aspects of the present disclosure.

FIGS. 9A and 9B are flowcharts illustrating rotary member operation processing according to the present exemplary embodiment.

FIGS. 10A, 10B and 10C are flowcharts illustrating directional pad processing according to one or more aspects of the present disclosure.

FIGS. 11A to 11I are diagrams for describing display indicating the direction of the virtual light source according to one or more aspects of the present disclosure.

FIG. 12 is a flowchart illustrating a modification of a setting screen display.

FIGS. 13A to 13E are diagrams illustrating a modification of the setting screen.

### DESCRIPTION OF THE EMBODIMENTS

Exemplary embodiments of the present disclosure will be described below with reference to the drawings.

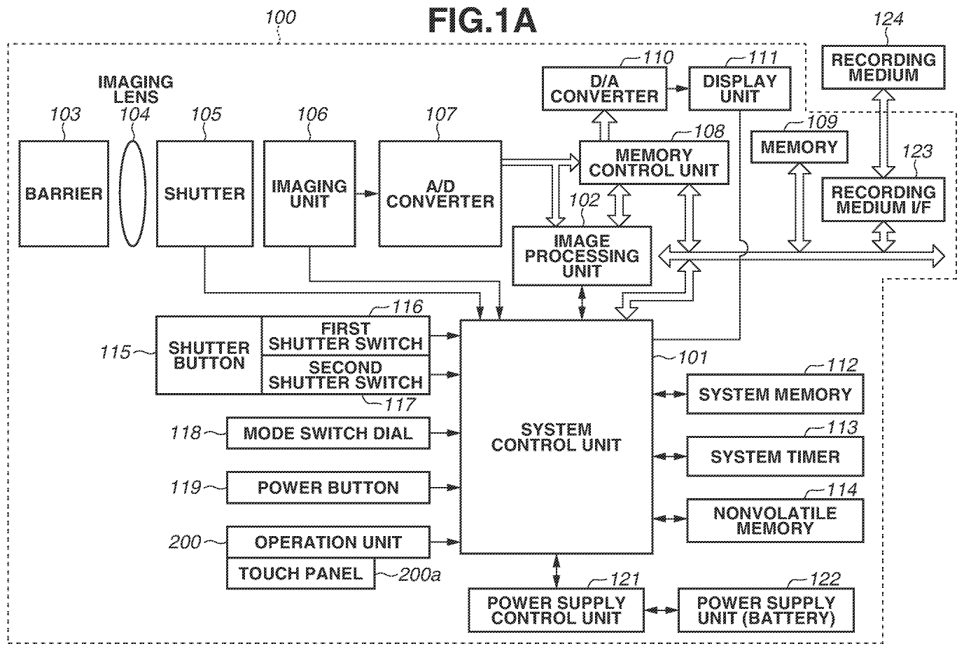

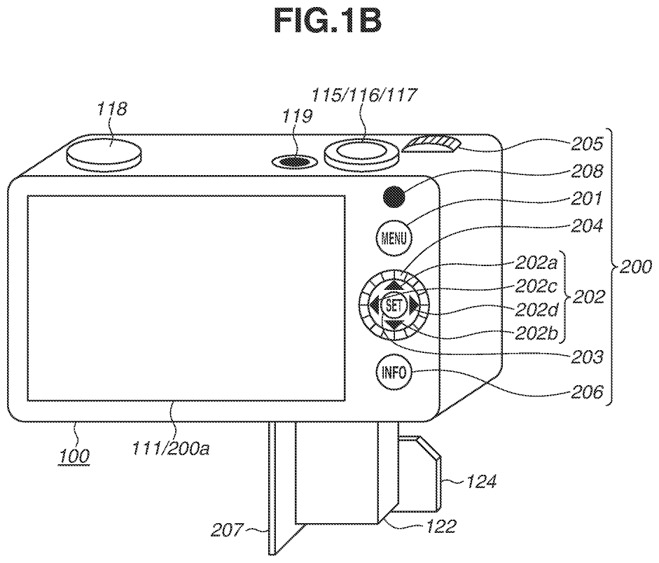

FIG. 1A is a block diagram illustrating a system configuration of a digital camera 100 that is an example of an apparatus to which an exemplary embodiment of the present disclosure can be applied. FIG. 1B is an external view of the digital camera 100.

In FIG. 1A, an imaging lens 104 is a lens group including a zoom lens and a focus lens. A shutter 105 has an aperture function. An imaging unit 106 is an image sensor including a charge-coupled device (CCD) or complementary metal-oxide-semiconductor (CMOS) element that converts an optical image into an electrical signal. An analog-to-digital (A/D) converter 107 converts an analog signal into a digital signal. The A/D converter 107 is used to convert an analog signal output from the imaging unit 106 into a digital signal. A barrier 103 covers an imaging system including the imaging lens 104 of the digital camera 100 to prevent the imaging system including the imaging lens 104, the shutter 105, and the imaging unit 106 from stains and damage.

An image processing unit 102 performs resizing processing, such as predetermined pixel interpolation and reduction processing, and color conversion processing on data from the AID converter 107 or data from a memory control unit 108. The image processing unit 102 also performs predetermined calculation processing using captured image data, and a system control unit 101 performs exposure control and ranging control based on the obtained calculation result. Through-the-lens (TTL) autofocus (AF) processing, automatic exposure (AE) processing, and preliminary flash emission (electronic flash (EF)) processing are therefore performed by the control. The image processing unit 102 further performs predetermined calculation processing using the captured image data, and performs TTL automatic white balance (AWB) processing based on the obtained calculation result.

Output data from the A/D converter 107 is written to a memory 109 via the image processing unit 102 and the memory control unit 108, or directly via the memory control unit 108. The memory 109 stores image data obtained by the imaging unit 106 and digitally converted by the A/D converter 107, and image data to be displayed on a display unit 111. The memory 109 has a sufficient storage capacity to store a predetermined number of still images or a predetermined duration of moving image and sound.

The memory 109 also serves as an image display memory (video memory). A digital-to-analog (D/A) converter 110 converts image display data stored in the memory 109 into an analog signal and supplies the analog signal to the display unit 111. The image data to be displayed, which is written in the memory 109, is then displayed on the display unit 111 via the D/A converter 110.

The display unit 111 performs displaying based on the analog signal from the D/A converter 110 on a display device, such as a liquid crystal display (LCD). The display unit 111 can function as an electronic viewfinder and display a through image by the D/A converter 110 analogously converting a digital signal that is once A/D converted by the A/D converter 107 and stored in the memory 109, and successively transferring the resulting analog signal to the display unit 111 for display. The through image displayed here will hereinafter be referred to as a live-view image.

A nonvolatile memory 114 is an electrically erasable and recordable memory. For example, an electrically erasable and programmable read-only memory (EEPROM) is used as the nonvolatile memory 114. The nonvolatile memory 114 stores operating constants and programs of the system control unit 101. As employed herein, the programs refer to ones for performing various flowcharts to be described below in the present exemplary embodiment.

The system control unit 101 controls the entire digital camera 100. The system control unit 101 implements various processes of the present exemplary embodiment to be described below by executing the programs stored in the foregoing nonvolatile memory 114. A system memory 112 includes a random access memory (RAM). The operating constants of the system control unit 101, variables, and the programs read from the nonvolatile memory 114 are loaded into the system memory 112. Moreover, the system control unit 101 performs display control by controlling the memory 109, the D/A converter 110, and the display unit 111. A system timer 113 is a clocking unit that measures time for various controls and time of a built-in clock.

A shutter button 115, a mode switch dial 118, a power button 119, and an operation unit 200 are operation means for inputting various operation instructions to the system control unit 101 (the system control unit 101 can detect operation performed on the operation unit 200).

The mode switch dial 118 switches the operation mode of the system control unit 101 between a still image recording mode, a moving image recording mode, a playback mode, and detailed modes included in the respective operation modes.

A first shutter switch 116 turns on to generate a first shutter switch signal SW1 in a case where the shutter button 115 on the digital camera 100 is operated halfway, i.e., half-pressed (imaging preparation instruction). Based on the first shutter switch signal SW1, the system control unit 101 starts operation of the AF processing, AE processing, AWB processing, and EF processing.

A second shutter switch 117 turns on to generate a second shutter switch signal SW2 in a case where the shutter button 115 is fully operated, i.e., full-pressed (imaging instruction). Based on the second shutter switch signal SW2, the system control unit 101 starts a series of imaging processing operations from reading of a signal from the imaging unit 106 to writing of image data to a recording medium 124.

A power supply control unit 121 includes a battery detection circuit, a direct-current-to-direct-current (DC-DC) converter, and a switch circuit for switching blocks to be energized. The power supply control unit 121 detects the state of the power button 119, the presence or absence of a battery attached, the type of battery, and the remaining battery level. Based on the detection results and instructions from the system control unit 101, the power supply control unit 121 controls the DC-DC converter to supply predetermined voltages to various parts including the recording medium 124 for predetermined periods.

A power supply unit 122 includes a primary battery, such as an alkali battery and a lithium battery, a secondary battery, such as a nickel-cadmium (NiCd) battery, a nickel metal halide (NiMH) battery, and a lithium-ion (Li) battery, and/or an alternating-current (AC) adapter. The present exemplary embodiment deals with a case where a secondary battery is used as the power supply unit 122 (hereinafter, referred to as a battery).

A recording medium interface (I/F) 123 is an I/F with the recording medium 124, such as a memory card and a hard disk. The recording medium 124 is a recording medium, such as a memory card for recording captured images. The recording medium 124 includes a semiconductor memory and/or a magnetic disk.

The operation unit 200 includes operation members that are assigned functions as appropriate scene by scene in response to the user performing selection operations on various function icons displayed on the display unit 111, and function as various function buttons. Examples of the function buttons include an end button, a back button, an image feed button, a jump button, a depth-of-field preview button, and an attribute change button. The operation unit 200 includes a touch panel 200a, a menu button 201, a multi controller 208, a directional pad 202, and a set button 203. The operation unit 200 further includes a controller wheel 204, an electronic dial 205, and an information (INFO) button 206. The directional pad 202 includes an up key 202a, a down key 202b, a left key 202c, and a right key 202d, and can be used to move a selected item and change the item to be selected. For example, in a case where the menu button 201 illustrated in FIG. 1B is pressed, a menu screen for various settings is displayed on the display unit 111. The user can intuitively perform various settings using the menu screen displayed on the display unit 111, the directional pad 202 including the up, down, left, and right, four direction buttons, and the set button 203. The controller wheel 204, the electronic dial 205, and the multi controller 208 are operation members included in the operation unit 200 that are capable of rotation operations, and used in specifying a selection item along with the direction buttons. in a case where operated to rotate, the controller wheel 204 and the electronic dial 205 generate electrical pulse signals based on the amounts of operation. The system control unit 101 controls various parts of the digital camera 100 based on the pulse signals. The angles of the rotation operations and the numbers of rotations of the controller wheel 204 and the electronic dial 205 can be determined from the pulse signals. The controller wheel 204 and the electronic dial 205 may be any operation members that can detect rotation operations. For example, the controller wheel 204 and the electronic dial 205 may be dial operation members that rotate themselves to generate pulse signals based on the user's rotation operation. Alternatively, the controller wheel 204 may be an operation member including a touch sensor, and detect a rotation operation of the user's finger on the controller wheel 204 without rotating itself (touch wheel). Like the directional pad 202, the multi controller 208 is a controller capable of issuing rightward, leftward, upward, and downward instructions. The multi controller 208 includes a lever and can issue the directional instructions in a case where the lever is tilted in the respective directions. The INFO button 206 is a button for switching the information amount of information display on the display unit 111. The information amount can be switched between normal, detailed, and hidden in order each time the INFO button 206 is pressed.

The battery 122 and the recording medium 124 can be inserted into the digital camera 100 from the bottom of the digital camera 100. An openable cover 207 can be put thereon as a lid.

The operation unit 200 also includes the touch panel 200a capable of detecting a touch on the display unit 111. The touch panel 200a and the display unit 111 can be integrally configured. For example, the touch panel 200a is configured so that its light transmittance does not interfere with the display of the display unit 111, and attached onto the display surface of the display unit 111. Input coordinates of the touch panel 200a and display coordinates on the display unit 111 (on the display surface) are then associated with each other. This can construct a graphical user interface (GUI) by which the user can perform operations as if directly operating the screen displayed on the display unit 111. The system control unit 101 (touch detection unit) can detect the following operations (touches) on the touch panel 200a:
A finger or a pen not touching the touch panel 200a newly touches the touch panel 200a. In other words, a start of a touch (hereinafter, referred to as a touch-down).
A finger or a pen is touching the touch panel 200a (hereinafter, referred to as a touch-on).
A finger or a pen touching the touch panel 200a moves (hereinafter, referred to as a touch-move).
A finger or a pen touching the touch panel 200a is released. In other words, an end of a touch (hereinafter, referred to as a touch-up).
Nothing touches the touch panel 200a (hereinafter, referred to as a touch-off).
A touch-up is performed in a short time after a touch-down on the touch panel 200a. A touch operation like tapping on the touch panel 200a (hereinafter, referred to as a tap).

The above-described operations and position coordinates of the touch performed by the finger or pen on the touch panel 200a are notified to the system control unit 101 via an internal bus. The system control unit 101 determines what operation is performed on the touch panel 200a based on the notified information. In the case of a touch-move, the moving direction of the finger or pen moving on the touch panel 200a can be determined in terms of vertical and horizontal components on the touch panel 200a separately, based on a change in the position coordinates. Performing a touch-down on the touch panel 200a and then performing a touch-up followed by a certain touch-move is referred to as drawing a stroke. An operation of drawing a quick stroke will be referred to as a flick. A flick is an operation of quickly moving a finger touching the touch panel 200a for a certain distance and immediately releasing the finger. In other words, a flick refers to an operation of quickly stroking the touch panel 200a with a finger as if flicking. A determination that a flick has been performed is made in a case where a touch-move over a predetermined distance or more at or above a predetermined speed is detected and a touch-up followed by the touch-move is then immediately detected. In a case where a touch-move performed over a predetermined distance or more below a predetermined speed is detected, a determination that a drag has been performed is made. Moreover, an operation of a finger or a pen moving into a specific area of the touch panel 200a during a touch-move (hereinafter, referred to as a move-in) and an operation of moving out from a specific area during a touch-move (hereinafter, referred to as a move-out) can also be detected. Furthermore, a touch operation of reducing a distance between two touch points, i.e., an operation like pinching a displayed image will be referred to as a pinch-in. A pinch-in is used as an operation for reducing an image or increasing the number of displayed images. A touch operation of increasing the distance between two touch points, i.e., an operation like spreading a displayed image will be referred to as a pinch-out. A pinch-out is used as an operation for enlarging an image or reducing the number of displayed images. A touch panel using any system may be used as the touch panel 200a. Examples include a resistive touch panel, a capacitive touch panel, a surface acoustic wave touch panel, an infrared touch panel, an electromagnetic induction touch panel, an image recognition touch panel, and an optical sensor touch panel.

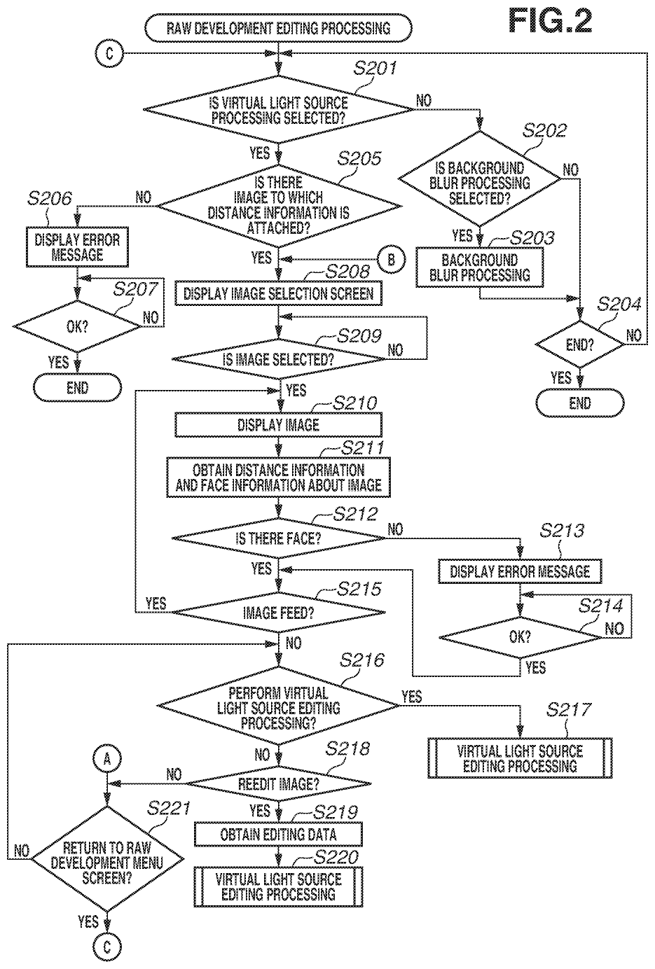

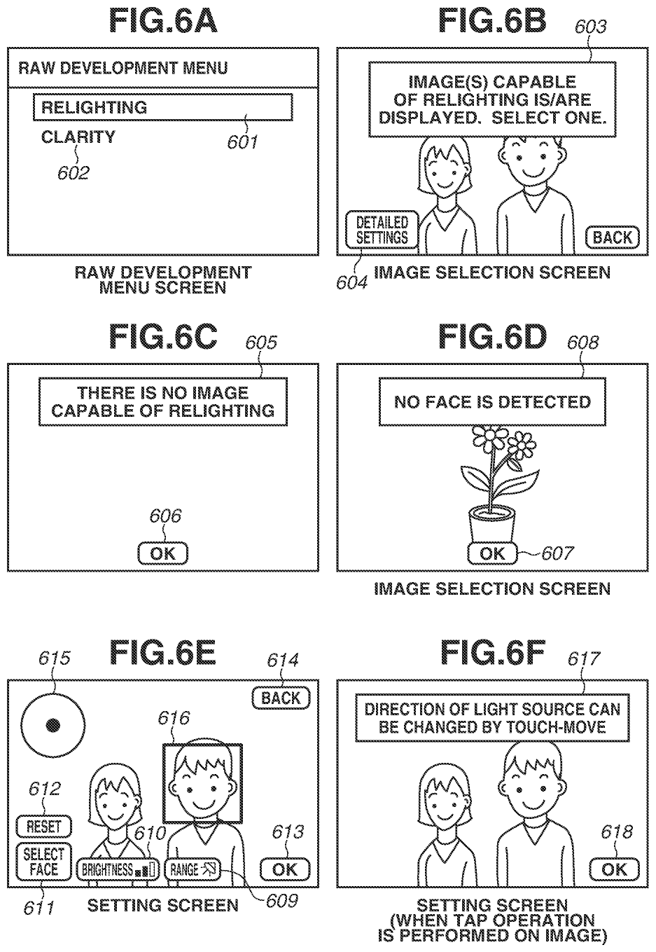

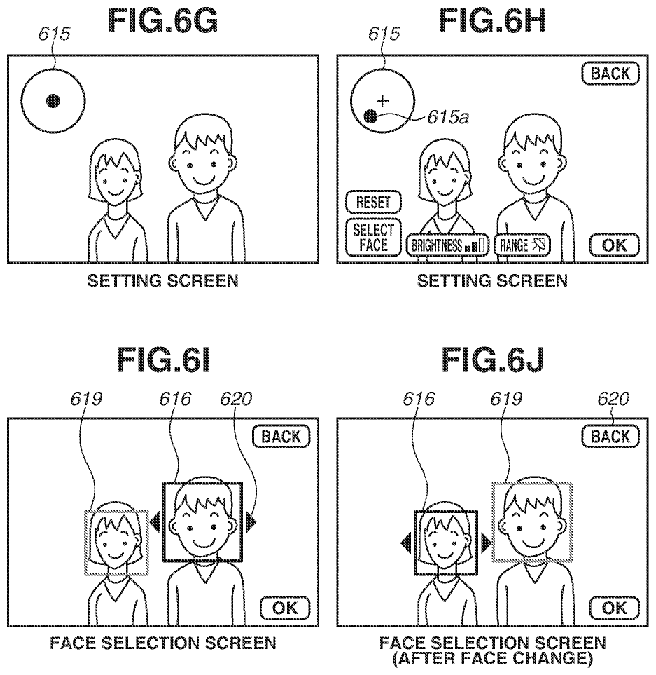

Next, raw development editing processing according to the present exemplary embodiment will be described with reference to FIG. 2. This processing is implemented by loading a program recorded in the nonvolatile memory 114 into the system memory 112 and executing the program by the system control unit 101. The processing of FIG. 2 is started, while the digital camera 100 is powered on, a playback menu is displayed on the menu screen, in a case where an item representing the raw development editing processing is selected. In a case where the item representing the raw development editing processing is selected, a raw development menu screen is displayed on the display unit 111. As illustrated in FIG. 6A, the raw development menu screen includes an item for performing processing for changing a direction of a virtual light source and an item for performing background blur processing. Both the processing for changing the direction of the virtual light source and the background blur processing are performed using depth information about an image by the control unit 101 (change unit). The item representing the raw development editing processing can be selected in imaging modes, such as a manual mode, an aperture priority (Av) mode, and a shutter speed priority (Tv) mode. The item representing the raw development editing processing is not selectable in modes where the digital camera 100 automatically performs settings for imaging items and perform imaging like an automatic imaging mode.

In step S201, the system control unit 101 determines whether virtual light source processing is selected. An item 601 in FIG. 6A is an item for proceeding to the virtual light source processing. An item 602 is one for proceeding to background blur processing. In a case where the item 601 is selected, the determination of step S201 is YES. In a case where the system control unit 101 determines that the virtual light source processing is selected (YES in step S201), the processing proceeds to step S205. In a case where the system control unit 101 determines that the virtual light source processing is not selected (NO in step S201), the processing proceeds to step S202.

In step S202, the system control unit 101 determines whether the background blur processing is selected. The background blur processing is processing for changing clarity of a background of a human figure or figures. Selection of the item 602 of FIG. 6A means that the determination of step S202 is YES. In a case where the system control unit 101 determines that the background blur processing is selected (YES in step S202), the processing proceeds to step S203. In a case where the system control unit 101 determines that the background blur processing is not selected (NO in step S202), the processing proceeds to step S204.

In step S203, the system control unit 101 performs the background blur processing.

In step S204, the system control unit 101 determines whether to end the raw development editing processing. In a case where the menu button 201 is selected to return to the menu screen, the shutter button 115 is pressed to enter an imaging screen, or the digital camera 100 is powered off, the determination of step S204 is YES. In a case where the raw development editing processing is determined to be ended (YES in step S204), the processing of FIG. 2 ends. If not (NO in step S204), the processing proceeds to step S201.

In step S205, the system control unit 101 determines whether there is an image to which distance information, i.e., information about image depth is attached among images recorded on the recording medium 124. The distance information is recorded as Exchangeable image file format (Exif) data on the image. In a case where the system control unit 101 determines that there is an image to which distance information is attached (YES in step S205), the processing proceeds to step S208. In a case where the system control unit 101 determines that there is no image to which distance information is attached (NO in step S205), the processing proceeds to step S206.

In step S206, the system control unit 101 displays an error message on the display unit 111. FIG. 6C illustrates a guide 605 displaying an example of the error message. In a case where the system control unit 101 determines that there is no image to which distance information is attached (NO in step S206), the processing proceeds to step S207 to end the raw development editing processing since the virtual light source processing is unable to be performed. In FIG. 6C, an item 606 representing OK for confirming that the user has read the content of the guide 605 is displayed.

In step S207, the system control unit 101 determines whether the item 606 representing OK is selected by the user. In a case where the item 606 is selected (YES in step S207), the raw development editing processing ends.

In step S208, the system control unit 101 displays an image selection screen on the display unit 111. FIG. 6B illustrates an example of the image selection screen. The image selection screen displays a guide 603 and an item 604 together with an image or images recorded on the recording medium 124. The guide 603 displays an instruction to select an image. The item 604 represents detailed settings for performing editing to change a direction of a virtual light source to be described below on the selected image.

In step S209, the system control unit 101 determines whether an image is selected. In a case where the number of images displayed on the display unit 111 is one, the displayed image is handled as an image selected by the user and the determination of step S209 is YES. As will be described below in step S215, in a case where a single image display (single playback) is performed, the image to be displayed can be changed (image feed) by the left and right keys 202c and 202d of the directional pad 202.

The image selection screen may display a single image as illustrated in FIG. 6B or simultaneously display a plurality of images (multi playback). Immediately after the processing is proceed to step S208, the latest image, the guide 603, and the item 604 are initially displayed as illustrated in FIG. 6B. In a case where a not-illustrated reduction button included in the operation unit 200 is operated or a pinch-in is performed by a touch operation, the number of displayed images can be increased. In a case where a plurality of images is displayed and any one of the images is selected by a user operation, the determination of step S209 is YES. In a case where, in step S209, the system control unit 101 determines that an image is selected (YES in step S209), the processing proceeds to step S210.

In step S210, the system control unit 101 displays the image on the display unit 111.

In step S211, the system control unit 101 obtains the distance information (depth information) about the image currently displayed and face information indicating whether a face is detected in the image.

In step S212, the system control unit 101 determines whether there is a face, based on the face information about the selected image, obtained in step S211. In a case where the system control unit 101 determines that there is a face, based on the face information (YES in step S212), the processing proceeds to step S215. In a case where the system control unit 101 determines that there is not a face, based on the face information (NO in step S212), the processing proceeds to step S213.

In step S213, the system control unit 101 displays an error message on the display unit 111. FIG. 6D illustrates an example of the error message. A guide 608 indicating that no face is detected is displayed here. In addition, an item 607 representing OK for confirming that the user has read the content of the guide 608 is displayed.

In step S214, the system control unit 101 determines whether the item 607 representing OK is selected by the user. In a case where the item 607 is selected (YES in step S214), the processing proceeds to step S215.

In step S215, the system control unit 101 determines whether an image feed is performed. An image feed can be performed by using the left and right keys 202c and 202d of the directional pad 202 or by a horizontal touch-move of a touch operation. In a case where the system control unit 101 determines that an image feed (changing of the image to be displayed) is performed (YES in step S215), the processing proceeds to step S210. In a case where the system control unit 101 determines that an image feed is not performed (NO in step S215), the processing proceeds to step S216.

In step S216, the system control unit 101 determines whether to perform virtual light source editing processing. The virtual light source editing processing refers to changing the state, such as a direction and intensity, of light from a virtual light source with respect to a person's face by using the virtual light source. The virtual light source editing processing can be performed by selecting the detailed settings represented by the item 604 illustrated in FIG. 6B. In a case where the system control unit 101 determines that the virtual light source editing processing is performed (YES in step S216), the processing proceeds to step S217. In a case where the system control unit 101 determines that the virtual light source editing processing is not performed (NO in step S216), the processing proceeds to step S218.

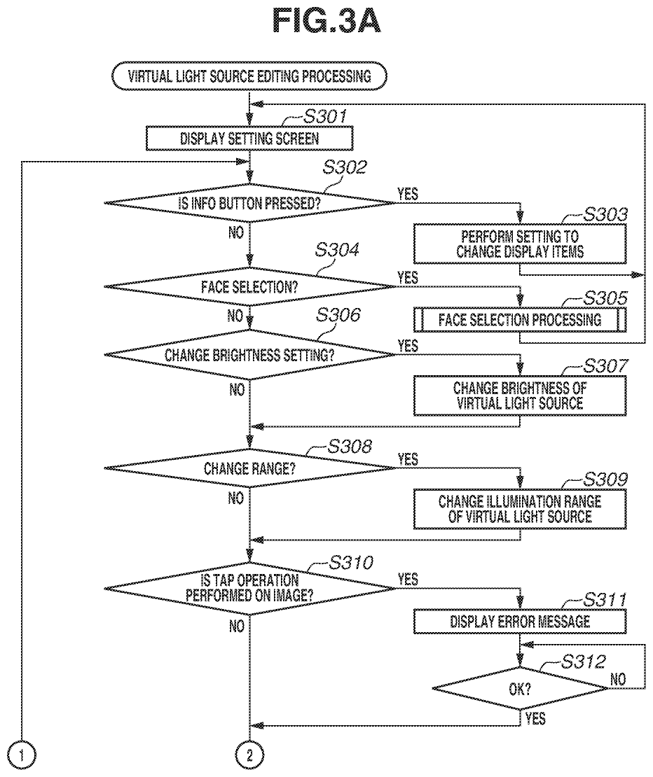

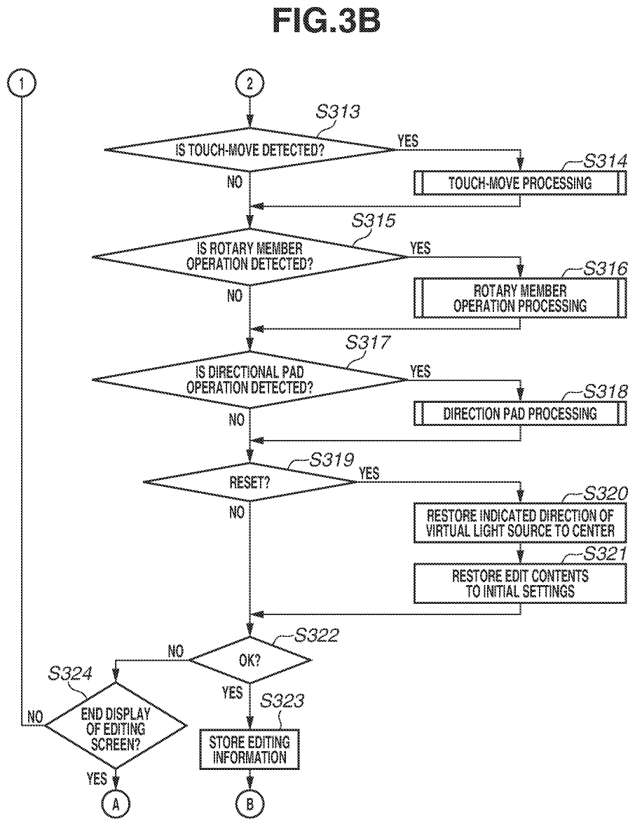

In step S217, the system control unit 101 performs the virtual light source editing processing. Details of the virtual light source editing processing will be described with reference to FIGS. 3A and 3B.

In step S218, the system control unit 101 determines whether to reedit the image. As will be described below, after the virtual light source editing processing is performed on an image, the edit contents are stored and additional editing processing can be continued on the stored contents. Specifically, in a case where the direction of the virtual light source is set in editing and a resultant image is once stored, light intensity of the virtual light source can be adjusted in the next editing with the direction of the virtual light source maintained the same as stored. In a case where the system control unit 101 determines that the image is reedited (YES in step S218), the processing proceeds to step S219. In a case where the system control unit 101 determines that the image is not reedited (NO in step S218), the processing proceeds to step S221. The previous edit contents can also be reset aside from being reedited.

In step S219, the system control unit 101 obtains editing data. The editing data may be recorded as Exif data along with the distance information and face information about the selected image. The editing data may be separately recorded on the recording medium 124. In a case where the determination of step S218 is YES and the processing proceeds to the virtual light source editing processing, the processing of FIGS. 3A and 3B is performed based on the editing data obtained in step S219.

In step S220, the system control unit 101 performs the virtual light source editing processing. Details of the virtual light source editing processing will be described below with reference to FIGS. 3A and 3B.

In step S221, the system control unit 101 determines whether to return to the raw development menu screen. To return to the raw development menu screen, the user presses the menu button 201. In a case where the system control unit 101 determines to return to the raw development menu screen (YES in step S221), the processing proceeds to step S201. In a case where the system control unit 101 determines not to return to the raw development menu screen (NO in step S221), the processing proceeds to step S216.

Next, the virtual light source editing processing according to the present exemplary embodiment will be described with reference to FIGS. 3A and 3B. This processing is implemented by loading a program recorded in the nonvolatile memory 114 into the system memory 112 and executing the program by the system control unit 101. The processing of FIGS. 3A and 3B is started when the processing of FIG. 2 proceeds to step S217 or S220.

In step S301, the system control unit 101 displays a setting screen on the display unit 111. FIG. 6E illustrates an example of the setting screen. The setting screen displays a plurality of items for performing respective editing operations together with the image (captured image) selected in step S209. The processing for changing the editable states of the virtual light source in the virtual light source editing processing will be described along with the items displayed on the setting screen.

An item 609 is used for processing to change the illumination range of the virtual light source in three levels. The illumination range of the virtual light source can be selected from among narrow, normal, and wide.

An item 610 is used for processing for changing the brightness of the virtual light source in three levels. The brightness of the virtual light source can be selected from among low, intermediate, and high.

An item 611 is used for changing the face to be selected. In the present exemplary embodiment, in a case where there is a plurality of faces detected, a face to be illuminated at the center by the virtual light source can be selected. As an example case, in a case where the user sets the direction of the virtual light source to the right, image processing is performed so that the selected face is illuminated from the right (as seen from the editing user) by the virtual light source. In a case where there is another face on the right (as seen from the editing user) of the selected face, another face is illuminated in the middle or from the left. In other words, to illuminate a face from the right by the virtual light source, the image processing desired by the user is performed by selecting the face. The user can switch the object to be illuminated at the center by the virtual light source by selecting the item 611.

An item 612 is used for resetting the edit contents. An item 613 is intended to save the edit contents.

An item 614 is used for returning to the image selection screen. An item 615 indicates the illumination direction of the virtual light source. An item 616 indicates the selected face (recognizably indicates a not-selected face or faces).

In step S302, the system control unit 101 determines whether the INFO button 206 is pressed. In a case where the system control unit 101 determines that the INFO button 206 is pressed (YES in step S302), the processing proceeds to step S303. In a case where the system control unit 101 determines that the INFO button 206 is not pressed (NO in step S302), the processing proceeds to step S304.

In step S303, the system control unit 101 performs a setting to change display items. In FIG. 6E, the setting screen is described to display the items 609 to 616. In editing an image by using the virtual light source, the user performs editing operations while observing the degree of illumination of the object(s) and the atmosphere. For that purpose, the display of the items can be switched on and off. In a case where the INFO button 206 is pressed, the items 609 to 614 and 616 are hidden as illustrated in FIG. 6G. The item 615 continues to be displayed since it indicates the illumination direction of the virtual light source.

In step S304, the system control unit 101 determines whether an instruction for face selection is issued. In other words, the system control unit 101 determines whether the item 611 is selected. In a case where the system control unit 101 determines that an instruction for face selection is issued (YES in step S304), the processing proceeds to step S305. In a case where the system control unit 101 determines that an instruction for face selection is not issued (NO in step S304), the processing proceeds to step S306.

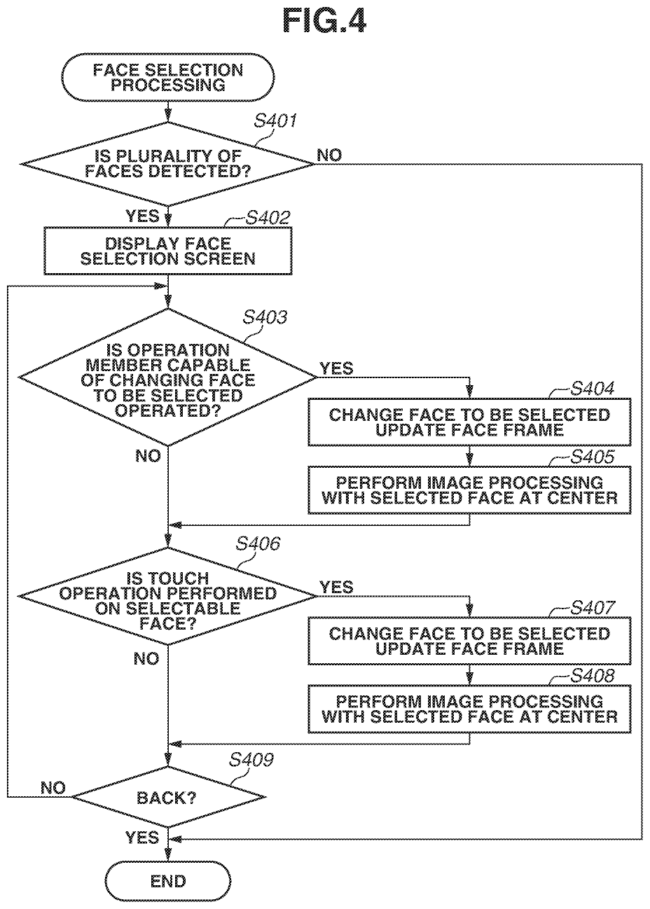

In step S305, the system control unit 101 performs face selection processing. The face selection processing will be described below with reference to FIG. 4.

In step S306, the system control unit 101 determines whether an instruction to change a brightness setting of the virtual light source is issued. In other words, the system control unit 101 determines whether the item 610 is selected. In a case where the system control unit 101 determines that an instruction to change the brightness setting is issued (YES in step S306), the processing proceeds to step S307. In a case where the system control unit 101 determines that an instruction to change the brightness setting is not issued (NO in step S306), the processing proceeds to step S308.

In step S307, the system control unit 101 changes the brightness of the virtual light source based on the user's instruction. In response to selection of item 610, the system control unit 101 displays items representing the three levels high, intermediate, and low so that the user can select the brightness level.

In step S308, the system control unit 101 determines whether an instruction to change the range of the virtual light source is issued. In other words, the system control unit 101 determines whether the item 609 is selected. In a case where the system control unit 101 determines that an instruction to change the range is issued (YES in step S308), the processing proceeds to step S309. In a case where the system control unit 101 determines that an instruction to change the range is not issued (NO in step S308), the processing proceeds to step S310.

In step S309, the system control unit 101 changes the illumination range of the virtual light source based on the user instruction. The item 609 is used for the processing for changing the illumination range of the virtual light source in three levels. In a case where the item 609 is selected, the system control unit 101 displays items representing the three levels of the illumination ranges of the virtual light source narrow, normal, and wide so that the user can select the range.

In step S310, the system control unit 101 determines whether a tap operation is performed on the image (excluding the items 609 to 614). The determination of step S310 is NO in a case where any of the areas in the image where the items 609 to 614 are displayed is tapped. In a case where the system control unit 101 determines that a tap operation is performed (YES in step S310), the processing proceeds to step S311. In a case where the system control unit 101 determines that a tap operation is not performed (NO in step S310), the processing proceeds to step S313.

In step S311, the system control unit 101 displays an error message on the display unit 111. FIG. 6F illustrates a guide 617 that is an example of the error message displayed in step S311. The guide 617 displays that the direction of the virtual light source can be changed by a touch-move. In the present exemplary embodiment, to distinguish operations for selecting the items displayed on the setting screen from operations for changing the direction of the virtual light source, a touch-move operation is used to enable change of the direction of the virtual light source. In a case where an area on the image where none of the items 609 to 614 is displayed is determined to be tapped, the system control unit 101 therefore displays the error message. Rejecting a change in the direction of the virtual light source by a tap operation can prevent the direction of the virtual light source from being unintentionally changed by the user's touch which is performed on a position deviated from the position of the item intended to select.

In step S312, the system control unit 101 determines whether an item 618 that represents OK and is displayed together with the guide 617 is selected. In a case where the item 618 is selected by the user (YES in step S312), the processing proceeds to step S313 since the system control unit 101 determines that the user has checked the guide 617.

In step S313, the system control unit 101 determines whether a touch-move is detected. In the present exemplary embodiment, a touch-move is accepted in the entire area of the setting screen. In a case where the system control unit 101 determines that a touch-move is detected (YES in step S313), the processing proceeds to step S314. In a case where the system control unit 101 determines that a touch-move is not detected (NO in step S313), the processing proceeds to step S315.

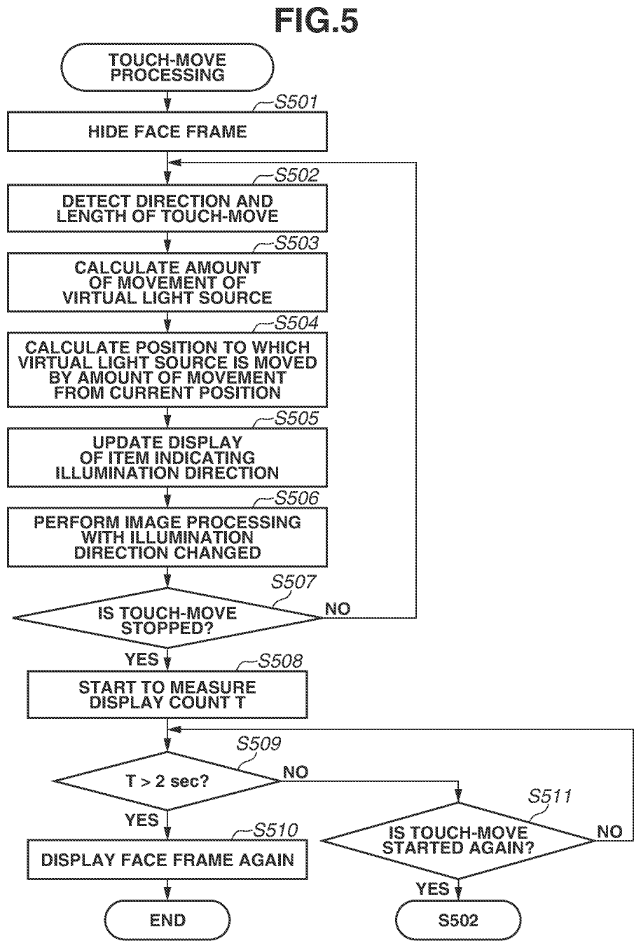

In step S314, the system control unit 101 performs touch-move processing. The touch-move processing will be described below with reference to FIG. 5.

In step S315, the system control unit 101 determines whether a rotary member operation is detected. A rotary member operation refers to a rotation operation on the electronic dial 205 or the controller wheel 204. In a case where the system control unit 101 determines that a rotary member operation is detected (YES in step S315), the processing proceeds to step S316. In a case where the system control unit 101 determines that a rotary member operation not detected (NO in step S315), the processing proceeds to step S317.

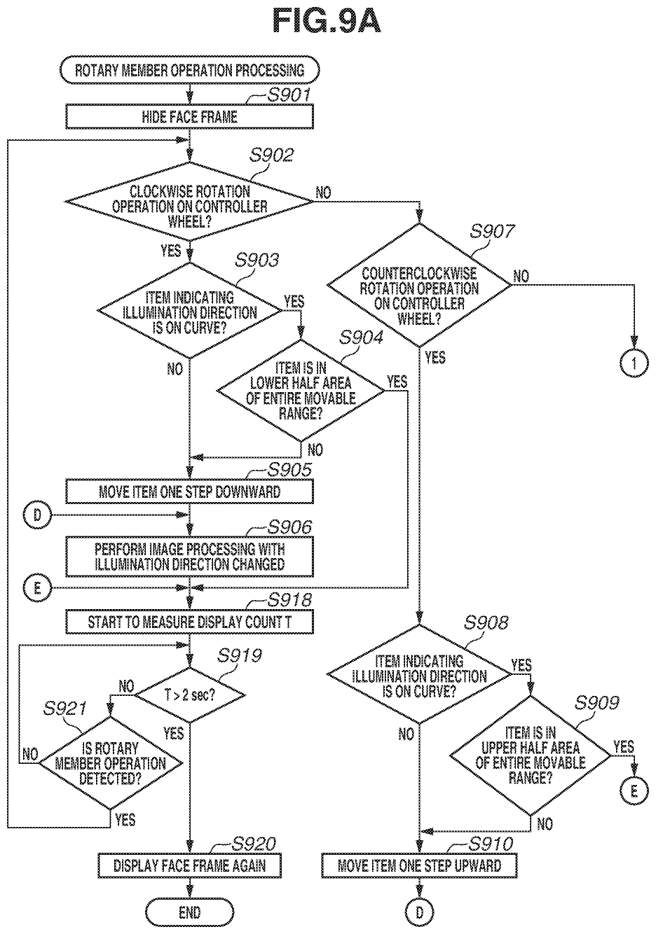

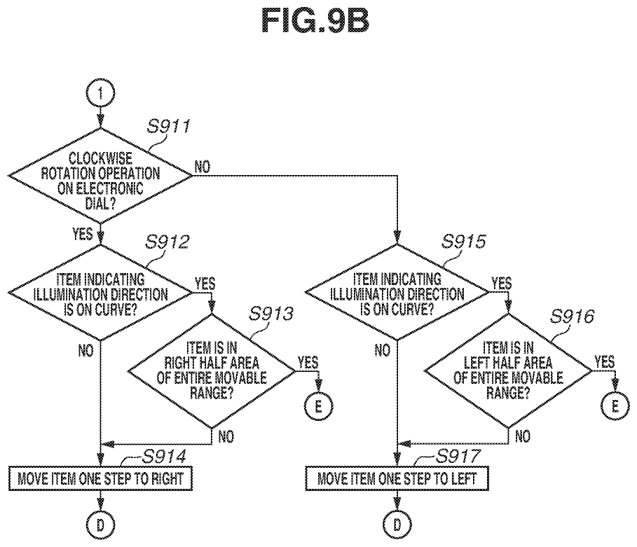

In step S316, the system control unit 101 performs rotary member operation processing. The rotary member operation processing will be described below with reference to FIGS. 9A and 9B.

In step S317, the system control unit 101 determines whether a directional pad operation is detected. In a case where any one of the keys of the directional pad 202 is operated, the determination of step S317 is YES (YES in step S317) and the processing proceeds to step S318. In a case where the system control unit 101 determines that no key of the directional pad 202 is operated (NO in step S317), the processing proceeds to step S319.

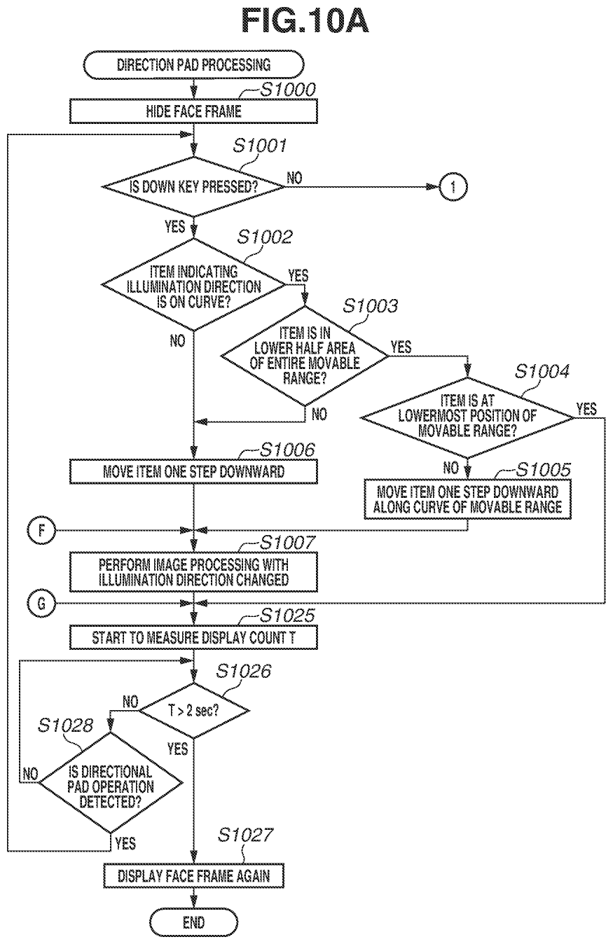

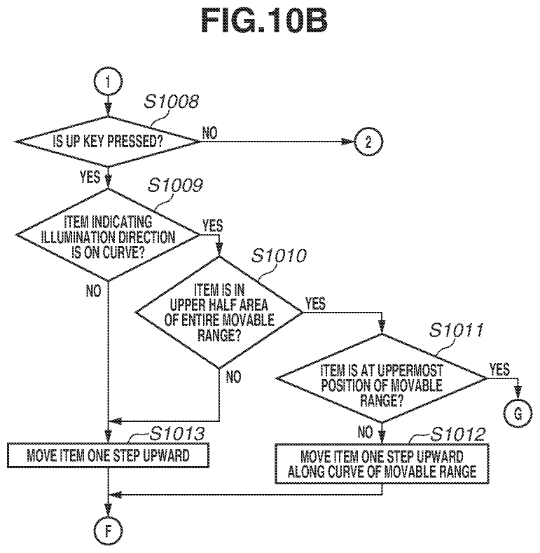

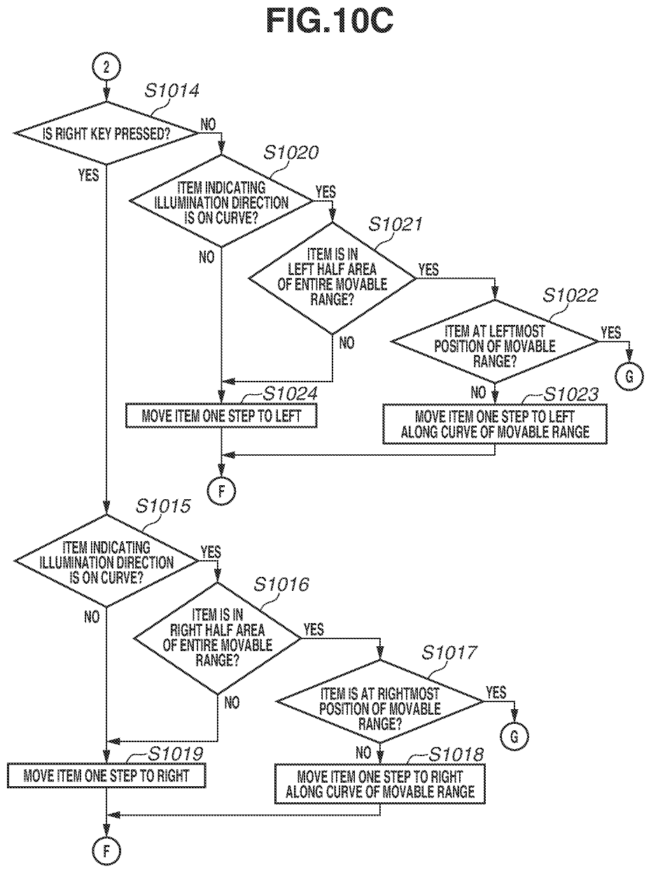

In step S318, the system control unit 101 performs directional pad processing. The directional pad processing will be described below with reference to FIGS. 10A and 10B.

In step S319, the system control unit 101 determines whether an operation for issuing an instruction to reset the editing contents about the virtual light source is performed. In other words, the system control unit 101 determines whether the item 612 is selected. In a case where the system control unit 101 determines that a reset instruction is issued (YES in step S319), the processing proceeds to step S320. In a case where the system control unit 101 determines that a reset instruction is not issued (NO in step S319), the processing proceeds to step S322.

In step S320, the system control unit 101 restores the direction of the virtual light source indicated by the item 615 to the center. The item 615 indicates the direction of the virtual light source. In a case where the direction of the virtual light source is changed, an item 615a moves from the center as illustrated in the item 615 of FIG. 6H. In step S320, the item 615a returns to the center position.

In step S321, the system control unit 101 restores each of the edit contents about the virtual light source to its initial settings. Specifically, the system control unit 101 restores the changed intensity and/or range of the virtual light source to the initial settings.

In step S322, the system control unit 101 determines whether an instruction to store the edit contents is issued. In other words, the system control unit 101 determines whether the item 613 representing OK is selected. In a case where the system control unit 101 determines that an instruction to store the edit contents is issued in step S322 (YES in step S322), the processing proceeds to step S323. In a case where the system control unit 101 determines that an instruction to store the edit contents is not issued (NO in step S322), the processing proceeds to step S324.

In step S323, the system control unit 101 stores the editing information (edit contents) about the virtual light source and records the editing information on the recording medium 124.

In step S324, the system control unit 101 determines whether an instruction to end the display of the setting screen is issued. In other words, the system control unit 101 determines whether the item 614 is selected. In a case where the system control unit 101 determines that an instruction to end the display of the setting screen is issued (YES in step S324), the processing returns to step S221 of FIG. 2. In a case where the system control unit 101 determines that an instruction to end the display of the setting screen is not issued (NO in step S324), the processing returns to step S302.

Next, the face selection processing according to the present exemplary embodiment will be described with reference to FIG. 4. This processing is implemented by loading a program recorded in the nonvolatile memory 114 into the system memory 112 and executing the program by the system control unit 101. The processing of FIG. 4 is started when the processing of FIG. 3A proceeds to step S305.

In step S401, the system control unit 101 determines whether a plurality of faces is detected, based on the face information obtained in step S211 of FIG. 2. In a case where the system control unit 101 determines that a plurality of faces is detected (YES in step S401), the processing proceeds to step S402. In a case where the system control unit 101 determines that a plurality of faces is not detected (NO in step S401), the processing of FIG. 4 ends.

In step S402, the system control unit 101 displays a face selection screen on the display unit 111. On the face selection screen, the user can select the object (face) around which the illumination direction of the virtual light source is changed. Selectable faces are determined based on face-related information recorded with the image. For example, an object (face) that is too small or blurred in the image is less likely to be detected as a face, and that face is likely to be not selectable on the face selection screen. FIG. 6I illustrates an example of the face selection screen. The item 616 is an item (face frame) indicating the currently selected face. Marks 620 representing arrows are displayed beside the item 616 to indicate that the item 616 can be moved. An item 619 is an item (face frame) indicating a selectable face.

In the present exemplary embodiment, the screen for accepting operations to select a face and the screen for changing the illumination direction (screen for changing the degree of effect) are switched so that when operations on one screen can be accepted, operations on the other are not. This facilitates the user to check the degree of effect when changing the illumination direction, since the item 619 indicating a selectable face is not displayed. This also enables the user to check the selected and selectable faces on the face selection screen.

The switching can also reduce the possibility that the user attempting to select a face by a touch operation accidentally moves the touch position, and the illumination direction is thus changed to an unintended direction. The switching can also reduce the possibility that the user attempting to change the illumination direction by a touch operation accidentally performs a touch on a face and the face to be selected is unintendedly changed. Alternatively, in a case where a face is selected or the illumination direction is changed not by touch operations but by operations on the operation members, the screen for accepting face selection and the screen for changing the illumination direction may be the same.

In step S403, the system control unit 101 determines whether an operation member capable of changing the face to be selected is operated. The face to be selected can be changed by operations for moving the multi controller 208 to the right and left or, in a case where a selectable face is above or below the currently selected face, by moving the multi controller 208 up or down. The face to be selected can also be changed by rotating the controller wheel 204. In a case where the system control unit 101 determines that an operation member capable of changing the face to be selected is operated (YES in step S403), the processing proceeds to step S404. In a case where the system control unit 101 determines that an operation member capable of changing the face to be selected is not operated (NO in step S403), the processing proceeds to step S406.

In step S404, the system control unit 101 performs processing for changing the face to be selected, and performs processing for updating the display of the item 616 indicating the selected face. FIG. 6J illustrates a display example when the face to be selected is changed from FIG. 6I. In FIG. 6J, the face on which the item 616 is displayed has changed from the right object to the left object.

In step S405, the system control unit 101 performs image processing for applying the virtual light source with the face selected in step S404 at the center. In a case where the face to be selected is changed, the image processing in step S405 is performed by taking over the illumination direction and brightness parameters having been set for the previously selected face. Alternatively, the image processing may be performed so that the virtual light source casts light from an initial direction each time the face is switched. Taking over the illumination direction having been set for the previously selected face is effective, for example, in a case where the right part of the image is dark as a whole and the user wants to cast light from the right and compare which face is the most appropriate for the virtual light source to illuminate at the center. The user can compare the degrees of effect on the faces to be selected by simply switching the faces on the face selection screen, without returning to the original screen for changing the illumination direction of the virtual light source and performing operations to change the illumination direction. The timing to reflect the effect of the virtual light source on the selected face may be immediately after the change or after a lapse of a certain time.

In step S406, the system control unit 101 determines whether a touch operation is performed on a selectable face. In a case where the system control unit 101 determines that a touch operation is performed on a selectable face, i.e., a face on which the item 619 is displayed (YES in step S406), the processing proceeds to step S407. In a case where the system control unit 101 determines that a touch operation is not performed (NO in step S406), the processing proceeds to step S409.

The processing of steps S407 and S408 is similar to that of steps S404 and S405.

In step S409, the system control unit 101 determines whether an operation for returning from the face selection screen to the setting screen is performed. The operation for returning from the face selection screen to the setting screen can be performed by selecting the item 620. In a case where the determination of step S409 is YES (YES in step S409), the processing of FIG. 4 ends. In a case where the determination of step S409 is NO (NO in step S409), the processing returns to step S403.

Next, the touch-move processing according to the present exemplary embodiment will be described with reference to FIG. 5. This processing is implemented by loading a program recorded in the nonvolatile memory 114 into the system memory 112 and executing the program by the system control unit 101. The processing of FIG. 5 is started in a case where the processing of FIG. 3B proceeds to step S314.

In step S501, the system control unit 101 hides the item 616 (face frame) indicating the selected face. FIG. 6H illustrates an example of the setting screen where the touch-move processing has been performed. In response to detection of a start of a touch-move at the state of the setting screen illustrated in FIG. 6E, the setting screen enters the state of FIG. 6H where the item 616 is hidden. Displaying the item 616 to indicate which face is selected facilitates the user to figure out the face that the virtual light source is currently illuminating at the center. On the other hand, continuing to display the item 616 around the face makes it less clear for the user to observe how the effect of illumination is changed. The item 616 is therefore hidden in response to a start of a touch-move to change the illumination direction (a start of changing the degree of effect). This facilitates the user to check the effect of the virtual light source while enabling identification of the selected object (since the item 616 is displayed until immediately before the effect of the virtual light source is changed). Instead of hiding the item 616, the system control unit 101 may reduce the overlapping area between the periphery of the selected face and the item 616, or display the item 616 in lighter color.

In step S502, the system control unit 101 detects the direction and length (vector) of the touch-move detected in step S313.

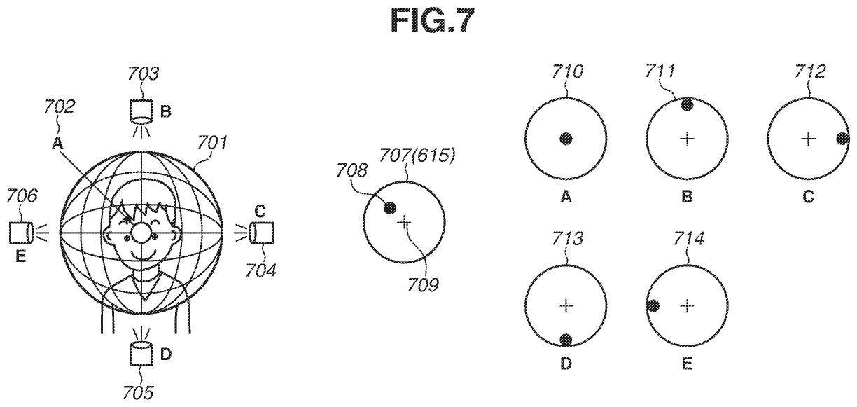

The illumination direction of the virtual light source and an item display for indicating the illumination direction will be described with reference to FIG. 7.

The virtual light source can be moved over a hemispherical surface area 701 covering the face front with the selected face at the center. The virtual light source is constantly directed to the center of the face, and the direction of the virtual light source can thus be freely changed by moving the virtual light source over the hemispherical surface area 701. The item 615 displayed on-screen expresses a state where the hemispherical surface area 701 is projected on a plane. The item 615 includes a movable range 707 of the virtual light source, an indicator 708 indicating the current position of the virtual light source (in FIG. 6H, the item 615a), and a center indicator 709 representing the apex of the hemispherical surface area 701. The virtual light source has representative positions 702 to 706 (referred to as positions A to E, respectively). Positions A to E are indicated on the item 615 indicating the illumination direction as on items 710 to 714, respectively. In a case where the parameters other than the illumination direction, like the brightness and the illumination range, are constant, the intensity of the light cast on the selected face from the virtual light source is the same regardless of the position of the item 615a. In other words, the virtual light source does not approach the selected face nor does the light intensify even in a case where the indicator 708 approaches the center indicator 709. The item 615 (movable range 707) is solely a two-dimensional representation of the hemisphere over which the virtual light source can move. The illumination direction of the virtual light source, or equivalently, the position of the virtual light source on the hemispherical surface area 701 can be changed by using the touch panel 200a and the operation member 120. As the illumination direction of the virtual light source changes, the indicator 708 indicating the illumination direction on the item 615 moves as well. The user can thus change the illumination direction of the virtual light source with a sense of moving the item 615a on the setting screen.

In a case where the item 615a is moved up to the defining line of the item 615 on the setting screen, the item 615a is unable to be moved further outward. For example, in a case where the item 615a is moved to the right end of the item 615 and the user performs an obliquely upward touch-move to the right, the item 615a moves only upward along the circumference (as much as the upward vector component of the touch-move).

Above is the description of FIG. 7.

In step S503, the system control unit 101 calculates the amount of movement of the virtual light source, i.e., the angle by which the virtual light source moves on the hemisphere based on the vector of the touch-move detected in step S502.

In step S504, the system control unit 101 calculates the position to which the virtual light source is moved by the amount of movement calculated in step S503 from the current position of the virtual light source.

In step S505, the system control unit 101 updates the display of the item 615 based on the position calculated in step S504.

In step S506, the system control unit 101 performs the image processing with the illumination direction of the virtual light source changed based on the position calculated in step S514. As described above, the illumination direction of the virtual light source is changed from the setting at the start of the touch-move based on the amount and direction of the touch-move, regardless of the position where the user has started the touch-move. Specifically, in a case where the virtual light source is illuminating the selected face from the right, the user can change the illumination direction by making a touch-move on the left part of the setting screen, without the user's finger performing the touch operation overlapping the selected face, and therefore visibility is not decreased. In addition, since no item representing the virtual light source is superimposed on the image on the setting screen but the item 615 indicating the direction of the virtual light source with respect to the selected object is displayed, the user can recognize the current illumination direction while performing a touch operation in a relative manner. In a case where an item representing the virtual light source is superimposed on the image on the setting screen and the illumination range of the virtual light source is set to be small, the item can be displayed to overlap the selected face or at a position very close to the selected face. Displaying the item 615 described in the present exemplary embodiment thus enables the user to change the illumination direction by touch operations with high visibility regardless of the user setting. While the face selection described in FIG. 4 is performed by selecting the object at the touched position on the image (absolute position designation), the illumination direction is changed by relative position designation. In selecting the object to apply the effect to, directly touching the target to be selected on-screen is easier for the user to understand. By contrast, the effect of the image processing on the object is easier to understand in a case where the effect can be changed in a relative manner.

In step S507, the system control unit 101 determines whether the touch-move is stopped. In a case where the system control unit 101 determines that the touch-move is stopped (YES in step S507), the processing proceeds to step S508. n a case where the system control unit 101 determines that the touch-move is not stopped (NO in step S507), the processing proceeds to step S502.

In step S508, the system control unit 101 starts to measure a display count T. The display count T refers to time intended to count the time to display the item 615 indicating the selected face, hidden in step S501, again. In the present exemplary embodiment, the item 615 is displayed again after a lapse of two seconds from the stop of the touch-move without a touch-move being started again.

In step S509, the system control unit 101 determines whether the display count T exceeds two seconds. In a case where the system control unit 101 determines that the display count T exceeds two seconds (YES in step S509), the processing proceeds to step S510. In step S510, the system control unit 101 displays the item 615 again. In a case where the system control unit 101 determines that the display count T does not exceed two seconds (NO in step S509), the processing proceeds to step S511.

In step S511, the system control unit 101 determines whether a touch-move is started again. In a case where the system control unit 101 determines that a touch-move is started again (YES in step S511), the processing proceeds to step S502. In a case where the system control unit 101 determines that a touch-move is not started again (NO in step S511), the processing proceeds to step S509.

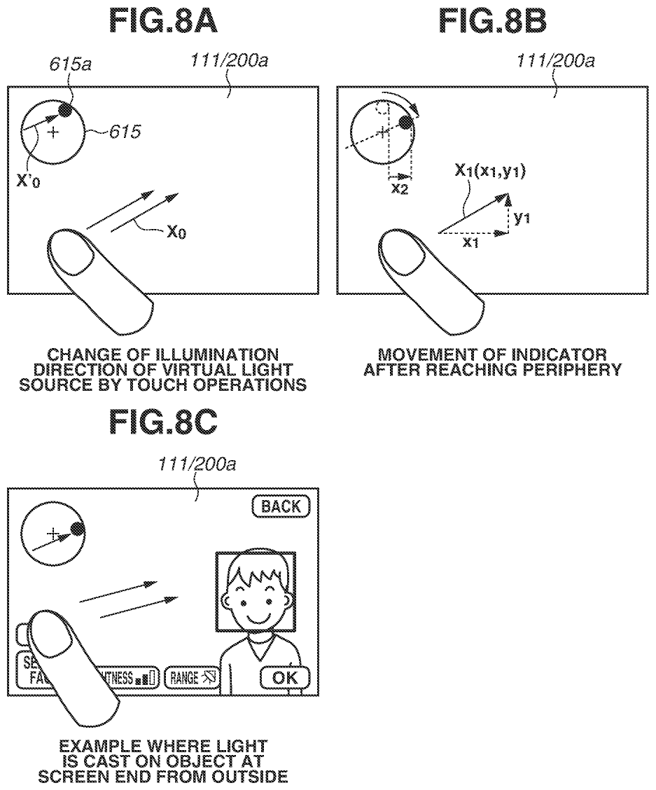

Now, the operation for changing the illumination direction of the virtual light source by a touch-move operation according to the present exemplary embodiment will be described with reference to FIGS. 8A to 8C.

As described above, the illumination direction is changed by a touch operation in a relative manner based on the direction and length of a touch-move. To move the virtual light source to an intended position (i.e., position indicating an intended illumination direction), as illustrated in FIG. 8A, the operator repeats a touch-move (drag) in the same direction a plurality of times so that the position of the item 615a reaches the intended position. In a case where the item 615a reaches the outer periphery of the hemispherical area described in FIG. 7 and the operator continues a touch-move toward an area beyond the hemisphere in this state, the indicator moves along the outer periphery based on the direction of the touch-move as illustrated in FIG. 8B. Specifically, in a case where, in FIG. 8A, the vector representing a touch-move performed by the user is Xo, the item 615a moves as much as vector X′₀ corresponding to vector X₀. In a case where the item 615a is on the circumference of the item 615 as a result of the movement in FIG. 8A and the user further performs a touch-move in an upper right direction in this state, the item 615a moves as follows. Where the vector representing the touch-move in FIG. 8B is X₁, and the amounts of movement on the x- and y-axes are x₁ and y₁, respectively, the item 615a moves along the circumference of the item 615 so that the item 615a moves in the x-axis direction by an amount of movement x₂ corresponding to the amount of movement x₁.

Since the position of the item 615a moves based on a relative relationship with a touch-move operation, the indicator can be moved in any direction regardless of where the touch-move operation is performed on the setting screen. This improves the operability of devices having a small screen, such as the digital camera 100 and a smartphone in particular.

Meanwhile, the method for designating a position on-screen in terms of an absolute position has an advantage that the position is intuitively recognizable. In the present exemplary embodiment, a selectable face can be at an end of the screen. Since the illumination direction of the virtual light source can be changed in a relative manner, the user can easily operate the illumination direction even in a case where the selected face is at the right end of the screen as illustrated in FIG. 8C.

Next, the rotary member operation processing according to the present exemplary embodiment will be described with reference to FIGS. 9A and 9B. This processing is implemented by loading a program recorded in the nonvolatile memory 114 into the system memory 112 and executing the program by the system control unit 101. The processing of FIGS. 9 and 9B is started in a case where the processing of FIG. 3B proceeds to step S316.

In step S901, like step S501 of FIG. 5, the system control unit 101 hides the item 616 (face frame) indicating the selected face.

In step S902, the system control unit 101 determines whether a clockwise rotation operation on the controller wheel 204 is accepted. In a case where a clockwise rotation operation is accepted (YES in step S902), the processing proceeds to step S903. In a case where a clockwise rotation operation is not accepted (NO in step S902), the processing proceeds to step S907.

In step S903, the system control unit 101 determines whether the item indicating the illumination direction (i.e., item 615a) is on the curve of the movable range (the circumference of the item 615). For example, positions B, C, D, and E illustrated in FIG. 7 are on the curve. In a case where the item 615a is on the curve (YES in step S903), the processing proceeds to step S904. In a case where the item 615a is not on the curve (NO in step S903), the processing proceeds to step S905. Instead of the determination on the position of the item 615a, whether the currently-set illumination direction is at an end (border position) of the possible range of illumination may be determined.

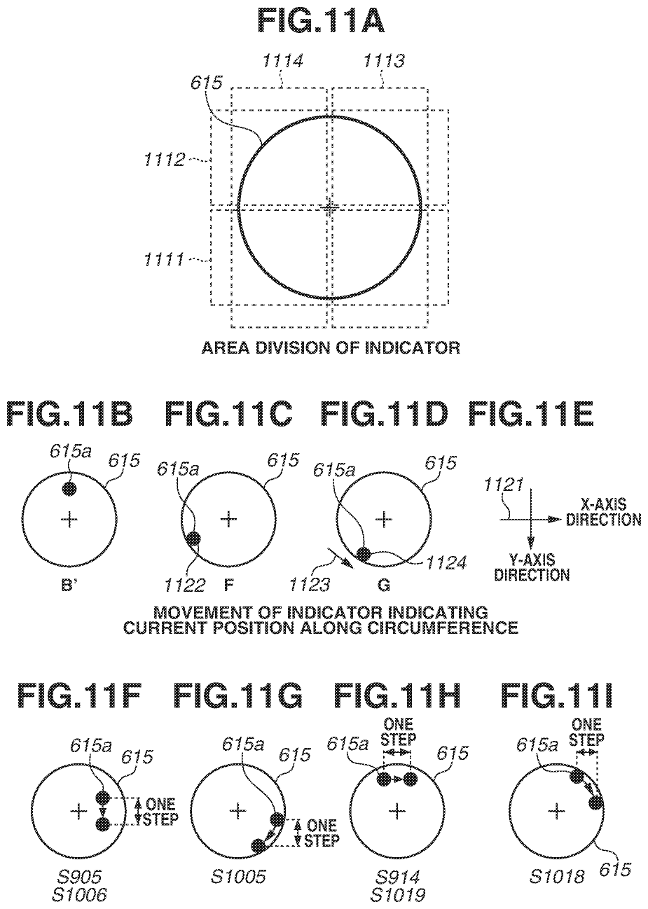

In step S904, the system control unit 101 determines whether the item 615a is in the lower half area of the entire movable range. As employed herein, the lower half area of the entire movable range refers to the area represented by an area 1111 in FIG. 11A. In a case where the item 615a is in the lower half area (YES in step S904), the processing proceeds to step S918. In a case where the item 615a is not in the lower half area (NO in step S904), the processing proceeds to step S905.

In the present exemplary embodiment, in a case where a rotary member is operated and the item 615a is on the curve of the movable range in the movement-instructed direction, the item 615a is not moved. For example, a description will be given of a case where the item 615a is at position F in FIG. 11C, and then moved to position G in FIG. 11D in response to a clockwise rotation of the controller wheel 204. The clockwise rotation of the controller wheel 204 is a downward movement instruction. In such a case, despite the clockwise rotation of the controller wheel 204, the item 615a moves counterclockwise (as indicated by an arrow 1123) on the curve (i.e., circumference) to move downward. Since the movement from a position 1122 to a position 1124 is a counterclockwise movement on the circumference, the moving direction of the item 615a is opposite to the direction of rotation of the controller wheel 204 by the user. By contrast, maintaining the item 615a stationary prevents such a sense of incongruity to the user. In other words, this provides intuitive operability for the user.

In step S905, the system control unit 101 performs processing for moving the item 615a one step downward. For example, the item 615a is moved downward from position B in FIG. 7 to position B′ in FIG. 11B. In other words, the clockwise rotation of the controller wheel 204 moves the item 615a downward (i.e., positively in the Y-axis direction of FIG. 11E).

In step S906, the system control unit 101 performs the image processing with the illumination direction of the virtual light source changed based on the user operation. In a case where the controller wheel 204 is rotated clockwise, the item 615a moves downward and the illumination direction moves upward.

In step S907, the system control unit 101 determines whether a counterclockwise rotation operation on the controller wheel 204 is accepted. In a case where a counterclockwise rotation operation is accepted (YES in step S907), the processing proceeds to step S908. In a case where a counterclockwise rotation operation is not accepted (NO in step S907), the processing proceeds to step S911.

In step S908, the system control unit 101 determines whether the item 615a is on the curve of the movable range (the circumference of the item 615). In a case where the item 615a is on the curve (YES in step S908), the processing proceeds to step S909. In a case where the item 615a is not on the curve (NO in step S908), the processing proceeds to step S910.

In step S909, the system control unit 101 determines whether the item 615a is in the upper half area of the entire movable range. As employed herein, the upper half area of the entire movable range refers to the area represented by an area 1112 in FIG. 11A. In a case where the item 615a is in the upper half area (YES in step S909), the processing proceeds to step S918. In a case where the item 615a is not in the upper half area (NO in step S909), the processing proceeds to step S910.

In step S910, the system control unit 101 performs processing for moving the item 615a one step upward.

In step S911, the system control unit 101 determines whether a clockwise rotation operation on the electronic dial 205 is accepted. In a case where a clockwise rotation operation is accepted (YES in step S911), the processing proceeds to step S912. In a case where a clockwise rotation operation is not accepted (NO in step S911), the processing proceeds to step S915.

In step S912, the system control unit 101 determines whether the item 615a is on the curve of the movable range (the circumference of the item 615). In a case where the item 615a is on the curve (YES in step S912), the processing proceeds to step S913. In a case where the item 615a is not on the curve (NO in step S912), the processing proceeds to step S914.

In step S913, the system control unit 101 determines whether the item 615a is in the right half area of the entire movable range. As employed herein, the right half area of the entire movable range refers to the area represented by an area 1113 in FIG. 11A. In a case where the item 615a is in the right half area (YES in step S913), the processing proceeds to step S918. In a case where the item 615a is not in the right half area (NO in step S913), the processing proceeds to step S914.

In step S914, the system control unit 101 performs processing for moving the item 615a one step to the right.

In step S915, the system control unit 101 determines whether the item 615a is on the curve of the movable range (the circumference of the item 615). In a case where the item 615a is on the curve (YES in step S915), the processing proceeds to step S916. In a case where the item 615a is not on the curve (NO in step S915), the processing proceeds to step S917. The processing of steps S915 to S917 is processing in a case where the electronic dial 205 is rotated counterclockwise, since the determination of step S911 is NO.

In step S916, the system control unit 101 determines whether the item 615a is in the left half area of the entire movable range. As employed herein, the left half area of the entire movable range refers to the area represented by an area 1114 in FIG. 11A. In a case where the item 615a is in the left half area (YES in step S916), the processing proceeds to step S918. In a case where the item 615a is not in the left half area (NO in step S916), the processing proceeds to step S917.

In step S917, the system control unit 101 performs processing for moving the item 615a one step to the left. In the present exemplary embodiment, a predetermined amount of rotation of the rotary member (as much as one pulse) moves the item 615a by one step. In terms of the illumination direction, one step represents the amount of movement equivalent to an angle such as 5° and 10°.

In step S918, like step S508 of FIG. 5, the system control unit 101 starts to measure the display count T.

In step S919, like step S509 of FIG. 5, the system control unit 101 determines whether the display count T exceeds two seconds. In a case where the system control unit 101 determines that the display count T exceeds two seconds (YES in step S919), the processing proceeds to step S920. In step S920, the system control unit 101 displays the item 616 (face frame) again. In a case where the system control unit 101 determines that the display count T does not exceed two seconds (NO in step S919), the processing proceeds to step S921.

In step S921, the system control unit 101 determines whether a rotary member operation is detected again. In a case where a rotary member operation is detected (YES in step S921), the processing proceeds to step S902. In a case where a rotary member operation is not detected (NO in step S921), the processing proceeds to step S919.

Next, the directional pad processing according to the present exemplary embodiment will be described with reference to FIGS. 10A and 10B. This processing is implemented by loading a program recorded in the nonvolatile memory 114 into the system memory 112 and executing the program by the system control unit 101. The processing of FIGS. 10A and 10B is started in a case where the processing of FIG. 3B proceeds to step S318.

In step S1001, like step S501 of FIG. 5, the system control unit 101 hides the item 616 (face frame) indicating the selected face. Hiding the item 616 indicating the selected face in response to an instruction performed to change the illumination direction of the virtual light source, whether by a touch operation described in FIG. 5 or by an operation using the directional pad 202 or a rotary member, makes the illumination effect easily discernible.

In step S1001, the system control unit 101 determines whether the down key 202b of the directional pad 202 is pressed. In a case where the system control unit 101 determines that the down key 202b is pressed (YES in step S1001), the processing proceeds to step S1002. In a case where the system control unit 101 determines that the down key 202b is not pressed (NO in step S1001), the processing proceeds to step S1007.

In step S1002, like step S903 of FIG. 9A, the system control unit 101 determines whether the item indicating the illumination direction (i.e., item 615a) is on the curve of the movable range (the circumference of the item 615). In a case where the system control unit 101 determines that the item 615a is on the curve (YES in step S1002), the processing proceeds to step S1003. In a case where the system control unit 101 determines that the item 615a is not on the curve (NO in step S1002), the processing proceeds to step S1005.

In step S1003, like step S904 of FIG. 9A, the system control unit 101 determines whether the item 615a is in the lower half area of the entire movable range. In a case where the item 615a is in the lower half area (YES in step S1003), the processing proceeds to step S1004. In a case where the item 615a is not in the lower half area (NO in step S1003), the processing proceeds to step S1006.

In step S1004, the system control unit 101 determines whether the item 615a is at the lowermost position of the movable range (on the curve). In other words, the system control unit 101 determines whether the item 615a is at a position where the item 615a is unable to move further downward. This state corresponds to position D of FIG. 7. In a case where the system control unit 101 determines that the item 615a is at the lowermost position of the movable range (YES in step S1004), the processing proceeds to step S1025. In a case where the system control unit 101 determines that the item 615a is not at the lowermost position of the movable range (NO in step S1004), the processing proceeds to step S1005.

In step S1005, the system control unit 101 moves the item 615a one step downward along the curve of the movable range. In other words, while the moving distance of the item 615a is greater than one step, the item 615a moves on the curve so that its coordinates change by one step positively in the Y-axis direction of FIG. 11E.

In step S1006, like step S905 of FIG. 9A, the system control unit 101 performs the processing for moving the item 615a one step downward.

In step S1007, like step S906 of FIG. 9A, the system control unit 101 performs the image processing with the illumination direction of the virtual light source changed based on the user operation.

In step S1008, the system control unit 101 determines whether the up key 202a of the directional pad 202 is pressed. In a case where the system control unit 101 determines that the up key 202a is pressed (YES in step S1008), the processing proceeds to step S1009. In a case where the system control unit 101 determines that the up key 202a is not pressed (NO in step S1008), the processing proceeds to step S1014.

In step S1009, like step S903 of FIG. 9A, the system control unit 101 determines whether the item indicating the illumination direction (i.e., item 615a) is on the curve of the movable range (the circumference of the item 615). In a case where the system control unit 101 determines that the item 615a is on the curve (YES in step S1009), the processing proceeds to step S1010. In a case where the system control unit 101 determines that the item 615a is not on the curve (NO in step S1009), the processing proceeds to step S1013.

In step S1010, like step S909 of FIG. 9A, the system control unit 101 determines whether the item 615a is in the upper half area of the entire movable range. In a case where the system control unit 101 determines that the item 615a is in the upper half area (YES in step S1010), the processing proceeds to step S1011. In a case where the system control unit 101 determines that the item 615a is not in the upper half area (NO in step S1010), the processing proceeds to step S1013.

In step S1011, the system control unit 101 determines whether the item 615a is at the uppermost position of the movable range (on the curve). In other words, the system control unit 101 determines whether the item 615a is at a position where the item 615a is unable to move further upward. This state corresponds to position B in FIG. 7. In a case where the system control unit 101 determines that the item 615a is at the uppermost position of the movable range (YES in step S1011), the processing proceeds to step S1025. In a case where the system control unit 101 determines that the item 615a is not at the uppermost position of the movable range (NO in step S1011), the processing proceeds to step S1012.

In step S1012, the system control unit 101 moves the item 615a one step upward along the curve of the movable range. In other words, while the moving distance of the item 615a is greater than one step, the item 615a moves on the curve so that its coordinates change by one step negatively in the Y-axis direction of FIG. 11E.

In step S1013, the system control unit 101 performs the processing for moving the item 615a one step upward.

In step S1014, the system control unit 101 determines whether the right key 202d of the directional pad 202 is pressed. In a case where the system control unit 101 determines that the right key 202d is pressed (YES in step S1014), the processing proceeds to step S1015. In a case where the system control unit 101 determines that the right key 202d is not pressed (NO in step S1014), the processing proceeds to step S1020.

In step S1015, like step S903 of FIG. 9A, the system control unit 101 determines whether the item indicating the illumination direction (i.e., item 615a) is on the curve of the movable range (the circumference of the item 615). In a case where the item 615a is on the curve (YES in step S1015), the processing proceeds to step S1016. In a case where the item 615a is not on the curve (NO in step S1015), the processing proceeds to step S1019.

In step S1016, like step S913 of FIG. 9B, the system control unit 101 determines whether the item 615a is in the right half area of the entire movable range. In a case where the item 615a is in the right half area (YES in step S1016), the processing proceeds to step S1017. In a case where the item 615a is not in the right half area (NO in step S1016), the processing proceeds to step S1019.

In step S1017, the system control unit 101 determines whether the item 615a is at the rightmost position (right end) of the movable range (on the curve). In other words, the system control unit 101 determines whether the item 615a is at a position where the item 615a is unable to move further to the right. This state corresponds to position C of FIG. 7. In a case where the system control unit 101 determines that the item 615a is at the rightmost position of the movable range (YES in step S1017), the processing proceeds to step S1025. In a case where the system control unit 101 determines that the item 615a is not at the rightmost position of the movable range (NO in step S1017), the processing proceeds to step S1018.

In step S1018, the system control unit 101 moves the item 615a one step to the right along the curve of the movable range. In other words, while the moving distance of the item 615a is greater than one step, the item 615a moves on the curve so that its coordinates change by one step positively in the X-axis direction of FIG. 11E.

In step S1019, like step S914 of FIG. 9B, the system control unit 101 performs the processing for moving the item 615a one step to the right.

In step S1020, like step S903 of FIG. 9, the system control unit 101 determines whether the item indicating the illumination direction (i.e., item 615a) is on the curve of the movable range (the circumference of the item 615). In a case where the item 615a is on the curve (YES in step S1020), the processing proceeds to step S1021. In a case where the item 615a is not on the curve (NO in step S1020), the processing proceeds to step S1024.

In step S1021, like step S916 of FIG. 9B, the system control unit 101 determines whether the item 615a is in the left half area of the entire movable range. In a case where the item 615a is in the left half area (YES in step S1021), the processing proceeds to step S1022. In a case where the item 615a is not in the left half area (NO in step S1021), the processing proceeds to step S1024.

In step S1022, the system control unit 101 determines whether the item 615a is at the leftmost position (left end) of the movable range (on the curve). In other words, the system control unit 101 determines whether the item 615a is at a position where the item 615a is unable to move further to the left. This state corresponds to position E of FIG. 7. In a case where the system control unit 101 determines that the item 615a is at the leftmost position of the movable range (YES in step S1022), the processing proceeds to step S1025. n a case where the system control unit 101 determines that the item 615a is not at the leftmost position of the movable range (NO in step S1022), the processing proceeds to step S1023.

In step S1023, the system control unit 101 moves the item 615a one step to the left along the curve of the movable range. In other words, while the moving distance of the item 615a is greater than one step, the item 615a moves on the curve so that its coordinates change by one step negatively in the X-axis direction of FIG. 11E.

In step S1024, like step S917 of FIG. 9B, the system control unit 101 performs the processing for moving the item 615a one step to the left.

The processing of step S1025 to S1027 is similar to that of steps S918 to S920 of FIG. 9A.

In step S1028, the system control unit 101 determines whether a directional pad operation is detected again. In a case where a directional pad operation is detected (YES in step SI028), the processing proceeds to step S1001. In a case where a directional pad operation is not detected (NO in step S1028), the processing proceeds to step S1026.

The movement of the item 615a in a case where the directional pad 202 (multi controller 208) or a rotary member is operated will be described with reference to FIGS. 11F to 11I. FIGS. 11F to 11I illustrate the state of the item 615a before and after movement. In a case where the down key 202b of the directional pad 202 is operated (the multi controller 208 is operated downward), the item 615a moves as illustrated in FIG. 11F. The item 615a also moves as illustrated in FIG. 11F in a case where the controller wheel 204 is rotated clockwise. In a case where, as illustrated in FIG. 11G, the item 615a before movement is on the curve of the movable range, the item 615a moves along the curve in response to the down key 202b of the directional pad 202 being operated.

Similarly, in a case where the right key 202d of the directional pad 202 is operated, the item 615a moves as illustrated in FIG. 11H. The item 615a also moves as illustrated in FIG. 11H in a case where the electronic dial 205 is rotated clockwise. In a case where, as illustrated in FIG. 11I, the item 615a is on the curve of the movable range, the item 615a moves along the curve.

In a case where the controller wheel 204 or the electronic dial 205 is operated to rotate and the item 615a is on the curve (border) of the movable range, the item 615a does not move along the curve.

As described above, in the present exemplary embodiment, the item 615a can move along the curve in response to an operation performed on the directional pad 202 or the multi controller 208. Since the directional pad 202 and the multi controller 208 are not a rotary member, the instructed direction of movement matches the direction of operation. The user is therefore less likely to have a sense of incongruity even in a case where the item 615a moves not just in the direction of operation but at least in the direction of operation, unless the item 615a moves in a direction opposite to the direction of operation. In the case of a rightward instruction, the user finds that the direction of operation matches the moving direction of the item 615a as long as the item 615a moves positively in the X-axis direction, even with some movement in the Y-axis direction, unless the item 615a moves negatively in the X-axis direction. As long as the direction of operation matches the moving direction of the item 615a, the user finds the item 615a moving based on the direction of operation and can make intuitive operations. Meanwhile, in a case where the item 615a does not move positively in the X-axis direction but moves only in the Y-axis direction or negatively in the X-axis direction despite a rightward instruction, the user is likely to feel that the item 615a is not moving based on the direction of operation. As described above, the processing for moving the item 615a is changed between the rotary members and the operation members of which the direction of operation matches the instructed direction of movement. This enables the user to operate any of the operation members with high operability.

In the directional pad processing, the operation member is not limited to the directional pad 202. For example, similar processing may be performed with a member that is singly capable of operations in a plurality of component directions, such as a joystick.

In the present exemplary embodiment, the controller wheel 204 and the electronic dial 205 are the only rotary members described. However, this is not restrictive. The foregoing processing (to not move the item 615a along the curve in a case where a rotary member is operated with the item 615a on the curve) may be performed on any rotary member that is disposed so that its rotation axis is orthogonal to the display plane of the indicator. Such a control provides the effect that the user can perform operations without a sense of incongruity.

The controller wheel 204 and the electronic dial 205 are capable of giving movement instructions along one axis each. The Y-axis direction that is the moving direction of the controller wheel 204 is orthogonal to the X-axis direction that is the moving direction of the electronic dial 205. The user therefore can confuse which operation member is used to move the item 615a in which direction if the user gives an instruction for movement in the X-axis direction and the item 615a moves also in the Y-axis direction that is the direction of movement instructions of the other operation member. By contrast, in a case where an operation member can singly issue movement instructions along two axes, like the directional pad 202 and the multi controller 208, the same operation member can issue movement instructions in both the X- and Y-axis directions. The user is therefore less likely to have a sense of incongruity as long as the item 615a moves at least in the instructed direction. The user's operability is thus improved by changing the movement control depending on which movement instruction the operation member can issue, a one- or two-axis movement instruction. The processing of FIGS. 9 and 10 is effective not only for movement within a circle, but also for movement within an area formed along (surrounded by) the X-axis on which movement instructions can be issued by operating an operation member and an axis different from the Y-axis orthogonal to the X-axis. Examples include a rhombus and an ellipse.

As described above, an effect of the present exemplary embodiment is that the user's finger performing a touch operation in changing the illumination direction of the virtual light source does not overlap the selected face, and therefore visibility is not decreased. Since the item 615 indicating the direction of the virtual light source with respect to the selected object is displayed, the user can observe the current illumination direction even while performing a touch operation in a relative manner. The user can thus perform operations for changing the illumination direction by touch operations with high visibility.

As described above, another effect of the present exemplary embodiment is that the user can easily observe the effect of the virtual light source and identify the selected object.

As described above, yet another effect of the present exemplary embodiment is that the user can make intuitive operations in a case where changing the illumination direction of the virtual light source by the rotary members.

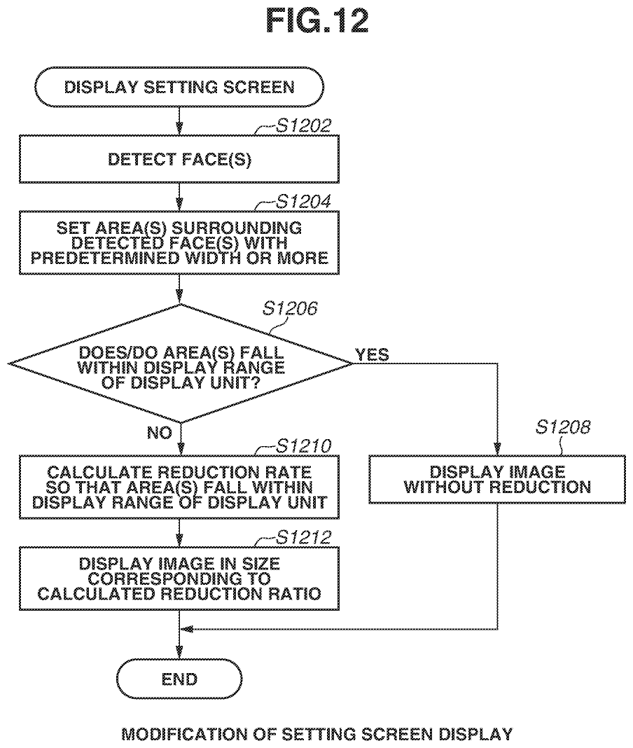

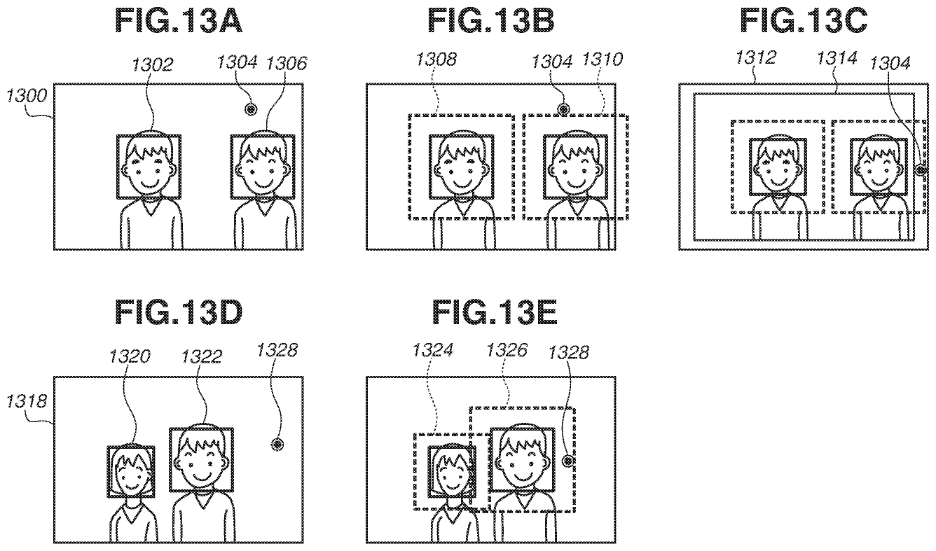

Next, a modification of the setting screen display in step S301 of FIG. 3A will be described with reference to the flowchart of FIG. 12 and the screen display examples of FIGS. 13A to 13E. In other respects than the setting screen display, the modification is similar to the exemplary embodiment described with reference to FIGS. 1 to 11I. In the modification, the item 615 is not displayed and the virtual light source is directly superimposed on the image (virtual light source 1304) for the purpose of description. However, the item 615 may be displayed.

FIG. 12 is a flowchart for describing the modification of the setting screen display in the processing of step S301.

In step S1202, the system control unit 101 detects a face included in the selected image. In a case where there is a plurality of faces, the system control unit 101 detects the plurality of faces.

FIGS. 13A to 13E illustrate screen display examples when processing for displaying the setting screen is performed.

FIG. 13A illustrates a state where faces included in an image 1300 (captured image) are detected. FIG. 13A illustrates that faces 1302 and 1306 are detected. In FIG. 13A, a virtual light source 1304 is superimposed on the image 1300. The virtual light source 1304 is an item indicating the direction in which the virtual light source casts light in performing processing for applying the effect of illuminating the detected face with the virtual light source. The virtual light source 1304 can be moved in terms of a relative position by the user's touch operations. The virtual light source 1304 can also be moved by using the directional pad 202 and/or the rotary members. The movement of the virtual light source is similar to in FIGS. 5, 9A and 9B, and 10A to 10C.

In step S1204, the system control unit 101 sets an area or areas surrounding the detected face(s) with a predetermined width or more for the face(s).

FIG. 13B illustrates a state where areas surrounding the detected faces with a predetermined width or more are set for the faces.

An area surrounding a face with a predetermined width or more defines an area where, in a case where the virtual light source is moved away from a face area by a predetermined distance or more, the effect of the virtual light source does not vary. In other words, the area is one obtained by extending the area where the face is recognized by a predetermined width or more, where the virtual light source has a certain or higher level of effect on the face. A certain or higher level of effect refers to an effect such that the application of the virtual light source is discernible on the display screen. The predetermined width corresponds to a position up to which the virtual light source can provide a certain or higher level of effect. Even in a case where the same face is selected, the width set in step S1204 therefore varies in response to a change by the user in the range or brightness of the virtual light source. Since the virtual light source is less likely to be disposed at a position so far that the effect of the image processing on the face is not discernible, a predetermined width is provided to improve operability while preventing the reduction ratio of the image from being too high or the visibility of the object from lowering. In other words, in a case where there is a selectable object in a center area of the display unit 111 (display surface), the image is displayed without reduction. In a case where there is no selectable object in the center area, the image is reduced.

In the modification, the predetermined width is 0.7 in length, with the length from the center of an area recognized as a face to an end of the area as 1. In a case where the predetermined width is too small for the face area, and a touch operation is performed while the image is displayed on the display unit 111 having a small size display such as that of the digital camera 100 or the face is at an end of the image, the virtual light source 1304 can overlap the face and cause the effect on the face to be difficult to observe. Meanwhile, in a case where the predetermined width is too large for the face area, the reduction ratio to be described below can be so high that the image effect becomes difficult to observe. In a case where there is an area having a width greater than or equal to a threshold around a face, the image therefore will not be reduced.

In FIG. 13B, an area 1308 is set for the face 1302, and an area 1310 is set for the face 1306. In a case where a plurality of faces is detected, an area is set for each face.

The shape of the area surrounding a face with a predetermined width or more is determined in consideration of the detection area of the face. In FIGS. 13A to 13E, the areas are rectangular since the detection areas of the faces are rectangular. The surrounding areas may be circular in a case where the detection areas of the faces are circular.

In step S1206, the system control unit 101 determines whether the area(s) set in step S1204 fall within the display range of the display unit 111. In a case where there is a plurality of areas set in step S1204, the system control unit 101 determines whether the plurality of areas falls within the display range of the display unit 111. In a case where the area(s) fall within the display range of the display unit 111 (YES in step S1206), the processing proceeds to step S1208. In a case where the area(s) does not fall within the display range of the display unit 111 (NO in step S1206), the processing proceeds to step S1210.

In the example of FIG. 13B, the system control unit 101 determines that the area 1310 does not fall within the display range of the display unit 111.

In a case where, in step S1206, the system control unit 101 determines that the area(s) does not fall within the display range of the display unit 111, then in step S1210, the system control unit 101 calculates the reduction ratio for displaying a reduced image so that the area(s) set in step S1204 fall within the display range of the display unit 111. Specifically, the image reduction ratio increases and the displayed size of the image decreases with decreasing distance between a face and an end of the display unit 111 or increasing size of the face.

In step S1212, the system control unit 101 displays the image on the display unit 111 in a size corresponding to the reduction ratio calculated in step S1210.

The determination of step S1206 is performed on all the plurality of faces. However, this is not restrictive, and the determination may be performed only on the selected face. Determination only on the selected face tends to provide a lower reduction ratio and higher image visibility. In a case where the determination is performed on all the faces, the display size of the image remains unchanged even in a case where the face to be selected is changed, and therefore operations for image processing can be favorably continued with the same size. Alternatively, the reduction ratio may be set to a constant value regardless of the position or size of the object(s).

FIG. 13C illustrates a state where an image 1314 obtained by reducing the image 1300 is displayed in a display area 1312 displayed on the display unit 111. In a case where, as illustrated in FIG. 13B, the area 1310 does not fall within the display range of the display unit 111, the reduced image 1314 is displayed. The image 1300 is reduced at a reduction ratio calculated so that the area 1310 falls within the display area 1312 of the display unit 111, and the reduced image 1314 is displayed. Since the reduced image 1314 is displayed, the virtual light source 1304 can be disposed on the right of the face 1306.

In a case where, in step S1206, the system control unit 101 determines that the areas (s) falls within the display range of the display unit 111 (YES in step in step S1206), the processing proceeds to step S1208. In step S1208, unlike step S1212, the system control unit 101 displays the image without reduction. That is, the same image is displayed in a larger size in step S1208 than in step S1212.

FIG. 13D illustrates a state where faces included in an image 1318 are detected. FIG. 13D illustrates that faces 1320 and 1322 are detected. FIG. 13D also illustrates a virtual light source 1328.

FIG. 13E illustrates a state where areas surrounding the detected faces with a predetermined width or more are set for the faces. An area 1324 is set for the face 1320, and an area 1326 for the face 1322. In FIG. 13E, both the areas 1324 and 1326 fall within the display range of the display unit 111, and thus the image 1318 is displayed without reduction. Since the virtual light source 1328 can be disposed on the right of the face 1322 or in other directions without reducing the image 1318, the user can perform the processing for changing the direction of the virtual light source with high operability.

As described above, in the modification, whether to display a reduced image or display an unreduced image is controlled based on information calculated from the face position(s). This facilitates moving the virtual light source even in a case where a face is at an end of the image and the user wants to move the virtual light source at a position which is outside the screen.

A reduced image may be displayed on condition that a face is in an area at an end of the image (i.e., not in the center area) (without taking into account the predetermined region(s) in step S1206). The determination of step S1206 may be performed only on the selected face. Similar effects can be obtained in a case where the virtual light source is operated and moved in terms of an absolute position base on the user's touch operations. Even in the case of moving the virtual light source to the user's touch position in terms of an absolute position, displaying a reduced image to leave margins around the face(s) improves the user's operability.

The targets of the virtual light source are not limited to human faces, and may be objects, for example, animals, vehicles, and buildings.

Moreover, the present exemplary embodiment is also applicable to a case of selecting two points that are a selected position and a position to perform predetermined processing, instead of the illumination direction of the virtual light source. For example, the present exemplary embodiment is applicable to the following case: an object is at a selected position, the user selects a position different from the selected position, and an image effect such that the object moves from the different position as if flowing or an image effect such that the object is stretched is applied to the object. In either of the cases where the illumination direction of the virtual light source is selected and where a position different from that of the selected object is selected to apply an image effect, the item 615 indicates the positional relationship between the selected object and a virtual position.

In the present exemplary embodiment, the item indicating the illumination direction of the virtual light source is described to move within a circle. However, this is just an example, and the item may move within a rhombus or an ellipse.

The present exemplary embodiment has been described by using the illumination of an object by the virtual light source as an example. However, this is not restrictive, and the present exemplary embodiment is also applicable to a case of performing editing to change color in the image or change the arrangement or size of an object in the image. Moreover, the present exemplary embodiment is not limited to still images, and may be applied to a moving image. In the present exemplary embodiment, only images having depth information are described. However, this is not restrictive.

The foregoing various controls described to be performed by the system control unit 101 may be performed by a single piece of hardware. A plurality of pieces hardware may control the entire apparatus by sharing processing.

While the present exemplary embodiment has been described in detail, the present disclosure is not limited to this specific exemplary embodiment. Various modes not departing from the gist of the disclosure are also included in the present exemplary embodiment. The foregoing exemplary embodiment demonstrates merely one exemplary embodiment of the present disclosure.

The foregoing exemplary embodiment has been described by using a case where the exemplary embodiment is applied to the digital camera 100 as an example. However, this example is not restrictive, and the present exemplary embodiment can be applied to any display control apparatus that can control image processing. Specifically, the present exemplary embodiment is applicable to a mobile phone terminal, a portable image viewer, a personal computer (PC), a printer apparatus including a viewfinder, a home appliance having a display unit, a digital photo frame, a projector, a tablet PC, a music player, a game machine, and an electronic book reader.

### (Other Exemplary Embodiments)

An exemplary embodiment of the present exemplary embodiment can also be implemented by performing the following processing. The processing includes supplying software (program) for implementing the functions of the foregoing exemplary embodiment to a system or an apparatus via a network or various recording media, and reading and executing the program code by a computer (or CPU or microprocessing unit (MPU)) of the system or apparatus. In such a case, the program and the storage media storing the program constitute exemplary embodiments of the present disclosure.

According to an exemplary embodiment of the present disclosure, the user's operability in changing the degree of effect on an object by a touch operation can be improved.

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)TM), a flash memory device, a memory card, and the like.

While the present disclosure has been described with reference to exemplary embodiments, the scope of the following claims are to be accorded the broadest interpretation so as to encompass all such modifications and equivalent structures and functions.

This application claims the benefit of Japanese Patent Application No. 2019-217579, filed Nov. 29, 2019, which is hereby incorporated by reference herein in its entirety.

What is claimed is:

1. A display control apparatus comprising:
a touch detection unit configured to detect a touch operation on a surface of a display;
a change unit configured to change a virtual position which is for performing predetermined image processing on an object displayed on the display; and
a control unit configured to display a first item indicating a positional relationship of the virtual position to the object, the control unit being configured to control the change unit, in a case where the touch detection unit detects a touch operation on the surface of the display, to not change the positional relationship indicated on the first item in response to a start position of the touch operation and to change the positional relationship indicated on the first item in response to movement of a touch position of the touch operation from a positional relationship indicated on the first item at a start of the touch operation.

2. The display control apparatus according to claim 1, wherein the control unit is configured to perform control to not change a position where the first item is displayed, even in a case where the touch operation is detected.

3. The display control apparatus according to claim 1, wherein the control unit is configured to perform control to change the predetermined image processing in response to movement of a touch position detected by the touch detection unit.

4. The display control apparatus according to claim 1, wherein the control unit is configured to control displaying of a guide in response to detection by the touch detection unit of a touch on the surface of the display and then a release of the touch without movement of a touch position, the guide indicating that the positional relationship is not changeable.

5. The display control apparatus according to claim 1, wherein the control unit is configured to perform control, in a case where a selection unit selects an object, to identifiably display an object at a touch position detected by the touch detection unit, and to perform control, in a case where the change unit changes the virtual position, to not display a touch position detected by the touch detection unit and change a positional relationship indicated by the first item in response to movement of the touch position.

6. The display control apparatus according to claim 1, wherein the first item is an item indicating an illumination direction of virtual light with respect to the object.

7. The display control apparatus according to claim 1, wherein the first item includes a second item indicating the object and a third item indicating a position of a virtual light source.

8. The display control apparatus according to claim 7, wherein the control unit is configured to perform control to change a position of the third item in response to detection by the touch detection unit of movement of a touch position.

9. The display control apparatus according to claim 1, wherein the predetermined image processing is image processing for virtually illuminating the object with light.

10. A display control apparatus comprising:
a touch detection unit configured to detect a touch operation on a surface of a display;
a selection unit configured to select any one of a plurality of objects displayed on the display;
a change unit configured to change a virtual position from which predetermined image processing is performed on the selected object; and
a control unit configured to control, in a case where the selection unit selects an object, the selection unit to select the object in response to a start position of a touch operation detected by the touch detection unit on the surface of the display, and control, in a case where the change unit changes the virtual position, the change unit to not change the virtual position in response to the start position of the touch operation detected by the touch detection unit on the surface of the display and to change the virtual position in response to movement of a touch position detected by the touch detection unit based on the movement of the touch position from the virtual position at a start of the touch operation.

11. The display control apparatus according to claim 10, wherein the control unit is configured to display a first item indicating a positional relationship of the virtual position to the selected object, wherein the control unit is configured to perform control, in a case where the touch detection unit detects a touch operation on the surface of the display, to not change a positional relationship indicated by the first item in response to a start of the touch operation, and to perform control to change a positional relationship indicated by the first item in response to movement of a touch position of the touch operation from a positional relationship indicated by the first item at a start of the touch operation.

12. A control method of a display control apparatus, comprising:
detecting a touch operation on a surface of a display;
changing a virtual position from which predetermined image processing is performed on an object displayed on the display; and
controlling displaying of a first item indicating a positional relationship of the virtual position to the object, the controlling including, in a case where the touch operation on the surface of the display is detected, not changing the positional relationship indicated on the first item in response to a start position of the touch operation and changing the positional relationship indicated on the first item in response to movement of a touch position of the touch operation from a positional relationship indicated on the first item at a start of the touch operation.

13. A non-transitory computer-readable storage medium storing a program for causing a computer to execute the control method according to claim 12.

14. A control method of a display control apparatus, comprising:
detecting a touch operation on a surface of a display;
selecting any one of a plurality of objects displayed on the display;
changing a virtual position which is for performing predetermined image processing on the selected object; and
performing control, in a case where an object is selected, to select the object in response to a start position of a touch operation detected on the surface of the display, and in a case where the virtual position is changed, performing control to not change the virtual position in response to the start position of the touch operation detected on the surface of the display and to change the virtual position in response to detection of movement of a touch position based on the movement of the touch position from the virtual position at a start of the touch operation.

15. A non-transitory computer-readable storage medium storing a program for causing a computer to execute the control method according to claim 13.
